(19) United States
(12) Patent Application Publication
(10) Pub. No.: US 2007/0253553 A1
(43) Pub. Date: Nov. 1, 2007

(54) System, Method of Generation and Use of Bilaterally Generated Variable Instant Passwords.

(76) Inventor: Syed Ibrahim Abdul Hameed Khan Abdul Rahman, Madurai (IN)

Correspondence Address: S A ABDUL RAHMAN;C/O: Mr. MANNY C RAJA, 1507, BERLIN ROAD, CHERRY HILL, NJ, 08003, US

(21) Appl. No.: 11/571,746

(22) PCT Filed: May 4, 2005
(86) PCT No.: PCT/IN05/00141

§ 371 Date: Jan. 7, 2007

(30) Foreign Application Priority Data
Jul. 12, 2004 (IN) IN2004/000205

(51) Int. Cl. H04L 9/00

(52) U.S. Cl. 380/259; 705/71

(57) ABSTRACT

In Bilaterally Generated Variable Instant Password system, Variable character sets or Master Variable Character Set with Sub Variable Character Sets of any level containing Character Units are used as means of generating Passwords. Password is a random combination of Character Units of Variable Character Set/derivatives, which is generated by a call of random numbers from SERVICE PROVIDER and corresponding response of USER. Bilaterally Generated Variable Instant Passwords and Non Repeating Bilaterally Generated Variable Instant Passwords are the two types of passwords that can be generated in this system. Font properties differentiation provides high password variability. Transformation of Variable Character Sets is also used to safeguard passwords. This system can authenticate persons, objects, individual actions initiated by USERs through separate passwords. Authentication of individual Internet Contract Transactions, Authenticated Dialogue Initiation, Automatic classification of USERs on access are special uses. This system can substitute all existing password systems including Biometric authentication.

### TECHNICAL FIELD

The invention relates to Bilaterally Generated Variable Instant Password System, a password system integrating functions of authentication, securing transactions, Call initiation, user classification and symmetric encryption key system, including independently securing every individual Internet Contract/Network transactions using two different computationally non intensive encryption keys/passwords per transaction, generating the keys/passwords from single password input of users and previously unknown users.

### PRIOR ART

International Application No: PCT/IN2004/000205 Date: Dec. 7, 2004 submitted by the same inventor disclosed few basic concepts of this invention. The present application is further improvement of the invention, over the earlier application.

Prior art password systems include Static passwords and Dynamic passwords or One-time passwords. Biometrics is also used for authentication. The prior art password systems are discussed below.

Static Password System: Static passwords are predefined, long before transactions and do not vary from transaction to transaction. Deficiencies of static password system are well known. However, in spite of deficiencies, it is the only password system that is widely used, due to non availability of a cost effective and versatile variable password system.

Dynamic Password Systems: Various Dynamic password systems or One-time password systems are available. But a number of deficiencies also are attributed to them. Some of the deficiencies are: Separate securing system is required to secure transactions after authentication.

Memorization is mandatory in prior art authentication devices. They are based on algorithms/pattern forming methods. PIN/Algorithm/Procedure memorization and entering PIN/recalling algorithm/procedure to generate each password is required. Some password systems have complex Algorithm/Procedures or method of generation making it difficult for users to use such password systems. Pattern based passwords are long.

There is a requirement that user and the authentication server should be synchronised. Validation calculation is computationally intensive. Large amount of wasted computations are involved before rejecting a wrong password.

Hard ware device for generating password requires, battery, initialization, resynchronization. Additional requirement of a third party authentication server, which has to validate the password generated from each user for the user account. The apparatus, method of generation and verification mechanism is expensive.

The authentication devices require additional reading devices and/or graphical user interfaces.

In pre-printed list of One-time passwords, user and service provider have to keep track of next to use password, which is cumbersome. Frequent replacement of password list and re-registration of passwords is required.

The authentication process of the present invention is analogous to a prior art method of Quality Assurance by Random Sample Testing of Batches. In this method, to verify quality compliance of a batch of materials, specified number of samples, are randomly selected from that batch, prescribed tests are conducted, and if tests on such selected samples pass the criteria for acceptance, the batch as a whole is accepted. The analogy is: User is issued with an authentication device, which has a number of identifying units. The materials to be tested are identifying units of authentication device. A few identifying units of authentication device are randomly called for from user. The order of random sample of identifying units to be tested is ensured. On furnishing by user, each part of selected identifying unit is tested to ascertain, whether it exactly match with the laid down specification for that identifying unit. If all selected identifying units pass the test, the whole batch is passed. Only the user, who has the full batch or the authentication device, could furnish the correct identifying units and therefore the user is authenticated.

There is a prior art authentication system using Random Partial Pattern Recognition principle. This system uses an authentication device having patterns as identifying units. Patterns are based on cognitive functions of position in the ordered set of data fields, which are easy to remember and operate. The patterns/pattern forming rules are memorized. This limits the number of patterns used in the authentication device to human memorizable level (about 9 only). Patterns are related to the serial number identifying the patterns. Also the patterns among themselves are related. The graphical characters of password occur at specified field location in graphical user interface corresponding to serial number identifying the patterns. This identifies graphical part of the patterns, serial number wise. The alphanumeric part of pattern is discernible within one password. Existence of relationship and identification of graphical part of the patterns, serial number wise, results in compromise of patterns and subsequent passwords. Patterns are too long and passwords are longer than any other variable password system. Finding characters through graphical user interface using starting point and reading path for each one of the graphical character in addition to keying in alphabets and numbers according to the patterns, is more difficult. The passwords are created with lot of efforts from user and not adoptable for authenticating individual transactions or authenticating objects. The system requires additional securing system to secure transactions. Graphical user interface is required to display and can not be used in systems not having suitable display devices such as mobile phones, cameras.

Certain features used in the authentication device, such as use of combination of alpha numeric and graphical characters, colours and property modification of characters are part of prior art, which have been adopted to suit the present invention.

Biometric authentication: Biometric authentication, achieves, near uniqueness of identity of a person but theoretically, an eight-character password offers, much more possible combinations, than what any biometric system could offer. Separate securing system is required to secure transactions following authentication. Biometric authentication is expensive. It requires special hardware and software. Criminals could steal biometric identifier data. Abuse of stolen biometric data is a distinct possibility. Being unique, once stolen, the biometric identification feature of a person could be abused forever.

Deficiencies common to prior art: Prior art password systems rely upon another securing method after authentication to secure transactions. There is no provision for continuous authentication of both user and service provider and individual objects exchanged using different passwords throughout a session. Transactions with previously unknown users are effected without ensuring security. Prior art claiming to authenticate Internet transactions, are based on the premise that authenticated access is adequate to ensure safe Internet transactions and they provide only authenticated access at the beginning of a session.

Most of the authentication/password systems including biometric authentication systems are primarily intended to authenticate users only i.e. the person in whose name an account exists, that too once at the beginning of a session. Only a few authentication systems provide for occasional re-authentication of user at some point of time during a session at the choice of service provider. Few Transaction Authentication Systems are known to be developed which are known to work on root certificates, hash functions based algorithms, and digital signatures that are computationally intensive. Such systems require intensive caching of keys and tracing of authentication through multiple keys, certificates and signatures using complex authentication logic, identify user to server (single step) transactions and not across many a transmitting servers or across servers which speak with many other servers, since key management becomes unwieldy. Such systems also do not authenticate each individual transaction but only a representative sample due to large volume of calculations to be done. The assumption of prior art that if a user is authenticated at the beginning of a session or occasionally in a session, all actions initiated from that user's computer are initiated by the user is not valid and the authentication provided by prior art is not adequate to ensure security of each one of the transactions.

After user has been authorized to do transactions, some one else does transactions using remote commands committing financial frauds. Virus attacks in Internet results in enormous loss of time, loss of productivity and huge restoration costs. Security breaches happen to high security systems established by large corporate entities. In all these, the problem creator is able to hide himself while launching attacks using illegally taken over remote computers. The attackers gain easy access because there is no authentication system to check individual actions/objects attempting to enter a user's/service providers computer. Lack of access control object wise, is a serious disadvantage of prior art.

Prior art authentication systems have no easy means to prove that a user is transacting with the correct party on the other side continuously from beginning to end of session. Though a few authentication systems provide for authentication of service provider initially or at some point of time during a session, this is not adequate to ensure security of all transactions. Unauthorized substitution of service provider or clandestine diversion of link between user and service provider takes place. The file or data packet containing important transactions transmitted in the net are captured and seen by unauthorized persons, as access restriction is not effective. Prior art in general do not restrict access to a specific service provider object. Virus, Spy ware, etc take advantage of inability to control, access, object wise, reach computers of users/service providers and access other objects in the computers to cause undesirable effects. Virus, Spy ware, etc, keep repeatedly accessing various objects in computers of users/service providers. Transaction wise control also is not there.

In Internet, a service provider has to come across new users or service provider has to do transactions with many previously unknown users. Such situations provide easy access to attackers, who could get away without being detected. Prior art authentication systems have no means to authenticate individual transactions of such users. Existing dynamic password systems are not capable of being implemented in non computer systems like mobile phones, digital camera.

When a user is in Internet, many unwanted web pages access a user's computer uninvited. There is no easy method available in prior art to control access by invitation or Call Initiation. Classification of users accessing a domain to allow access to specific access controlled sub domains is at present done by asking users to furnish details every time, users seek access to such access controlled sub domains. This repeated furnishing of information by users, results in wastage of time and resources of users and service providers. There is no easy method in prior art to solve this problem.

The present invention aims to provide a simple, versatile, user friendly, economical, highly secure, variable, flexible, multifunctional password cum encryption key system overcoming all the above deficiencies in prior art

### OBJECT OF THE INVENTION

The present invention has the following objectives:

A self reliant Password system to generate encryption keys to secure Internet/network transactions. The Password system itself shall provide two variable computationally non intensive encryption keys, linked to the identity of user for authentication and securing of each transaction and objects exchanged in Internet/network transactions.

The password is easily generated both by human users as well as user objects. The password system shall dispense with mandatory requirement on user to furnish a memorized PIN or follow difficult procedures or have special implementing devices thereby curtailing the flexibility of producing variable passwords by other than human users.

A specific service provider with clearly defined boundaries seeking a variable password each time an object seeks access, especially for all objects received/down loaded from Internet, is to be envisaged. User is restricted from accessing whole of the service provider system. Service provider also is continuously authenticated optionally.

Variable passwords for every transaction, with transaction limited to an action of user and subsequent Response of service provider. For every access to a service provider's system, a different password is used optionally. The apparatus, method of generation and verification mechanism have to be suitable for generating a multitude of passwords, easily so as to make it available for each transaction.

Since every transaction has to be authenticated, it will be expensive to have a separate server system to authenticate. Therefore verification mechanism is resident in the service provider's system.

When human control is required on access, it might be burdensome for human user to furnish individual variable passwords for every transaction or access. Hence the password system is designed to produce many passwords using only one initial password furnished by user in a session and every such generated password is traceable to the particular user, transaction and session.

When a service provider has to come across new users/previously unknown users, every transaction of such users have to be identified with separate passwords generated from temporary authentication device, each of the individual actions/objects exchanged between them are authenticated and every such generated password is traceable to new users/previously unknown users, transaction and session.

A simple, computationally non intensive password system adoptable to all users, capable of being implemented in non computer systems like mobile phones, digital camera, or similar devices is provided.

An easy Call initiation method or means of verification as to the party seeking access to a system is the party invited for dialogue, even when the party is unknown to user.

An easy means of classification of users on access, without requirement on user to furnish details before access to controlled sub domains is provided.

The security provided by the passwords is equal or higher than what is available in the present password systems and security level is not predetermined by the password system but designable by service provider suiting the requirement of users.

The cost is minimal and commensurate with the security and other features obtained.

### SUMMARY OF THE INVENTION

With above objectives, the invention is summarized below:

The first embodiment of the invention is directed to the Bilaterally Generated Variable Instant Password System, that integrates functions of authenticated Call initiation, User Classification, Symmetric encryption key system, user authentication and securing each one of the Internet/network transactions of users/previously unknown users by providing two different computationally non intensive encryption keys linked to user's identity.

The second embodiment of the invention is directed to the Variable Character Set system of authentication devices, having Variable Character Set, Master Variable Character Set, Sub Variable Character Set and Sub Variable Character Set of level 2 and below, including their method of generation and use.

The third embodiment of the invention is directed to a method of repeated variation of font/distinguishing properties as means of differentiation between same characters of Password, in printed authentication devices of the second embodiment to obtain higher variability, safety and flexibility of the second embodiment.

A fourth embodiment of the invention is directed to the transformation of the second embodiment to obtain higher safety.

The fifth embodiment of the invention is directed to the authentication process of the first embodiment.

The sixth embodiment of the invention is directed to the Bilaterally Generated Variable Instant Passwords generated using the above embodiments.

The seventh embodiment of the invention is directed to the Non Repeating Bilaterally Generated Variable Instant Passwords generated using the first five embodiments.

The eighth and ninth embodiment of the invention is directed to the special method of using the first seven embodiments, for access control/data protection/simple devices substitute to Biometric authentication and use as an independent encryption key system.

The tenth embodiment of the invention is directed to the method of authentication and securing of every individual Internet Contract/Network transactions of user with one password furnished by a user for each transaction in which each of the individual actions/objects exchanged between user and service provider are authenticated using the Call and Password as two different passwords/encryption keys for each transaction, using first seven embodiments.

The eleventh embodiment of the invention is directed to the method of authenticating and securing of every individual Internet Contract/Network transaction of a user with different passwords, generating the said different passwords from a single password furnished by user at the beginning of a session and every transaction is authenticated with different password so generated in which each of the individual actions/objects exchanged between user and service provider are authenticated using first seven embodiments.

The twelfth embodiment of the invention is directed to the method of authentication and securing of every individual Internet/Network transaction of a previously unknown user with different passwords, generating said different passwords from single Password furnished from a temporary authentication device at the beginning of a session and every transaction is authenticated with different password so generated in which each of the individual actions/objects exchanged between user and service provider are authenticated using first six embodiments.

The thirteenth embodiment of the invention is directed to the Authenticated Dialogue Initiation between a user and another party, in Internet, who is known or unknown to the user to identify called parties to grant preferred access and optionally deny access to uncalled/uninvited parties, a direct and computationally non intensive Call initiation method, using first six embodiments.

The fourteenth embodiment of the invention is directed to the Automatic classification of users on access to reduce one or more stages of communication in Internet, using first seven embodiments.

### DETAILED DESCRIPTION OF THE INVENTION

A detailed description of the invention is provided below. While the invention is described in conjunction with specific embodiments, it should be understood that the invention is not limited to specific embodiments. On the contrary, the scope of the invention is limited only by the appended claims and the invention encompasses numerous alternatives, modifications and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical field related to the invention has not been described in detail.

Definitions: For the purpose of this description, the technical terms used are defined below.

Access restriction: It is to restrict access of the USER to within confines of the specified SERVICE PROVIDER by specifying the boundaries of SERVICE PROVIDER.

Authentication device: It is the means of generating Password in the Bilaterally Generated Variable Instant Password System and includes Variable Character Set/Sub Variable Character Set of any level for USERs and Variable Character Set/Master Variable Character Set for SERVICE PROVIDERs with an associate Sub Variable Character Set of any level in brief form.

Authentication and securing of every individual transactions: It is to authenticate every individual transaction using different Passwords linked to USER and providing different encryption keys for encrypting every transaction.

Basic Characters (BC): It is single character used to form Character Unit and selected from any type of characters like Alphabets, Numbers and Symbols, from any language or script or number or symbol systems with or without any font/distinguishing property including any representation of objects such as diagrams, drawings, images, photos, pictures, sketches, identified as distinct units, with or without any distinguishing property.

Bilaterally Generated Variable Instant Password System: It is a variable Password system, integrating authentication of users, securing every Internet/network transactions of users, access control, Call initiation, user classification and an encryption key system in which, the Passwords are generated bilaterally, by USER and SERVICE PROVIDER acting together, at the instant of transaction and the Passwords are variable for every transaction.

Bilaterally Generated Variable Instant Password (BIGVIP): It is a Password generated using the Bilaterally Generated Variable Instant Password system in which, in any Password Call, any Character Unit of the Variable Character Set/Sub Variable Character Set of any level that has been called previously for a Password could be called again and again for subsequent Passwords without any restriction and a Password could repeat rarely.

Call: It is a Call of SERVICE PROVIDER to USER or vice versa, in terms of serial numbers of Character Units, requiring a Response to furnish Character Units of the authentication device. The Call is made of instantly generated random numbers, each of which is equal to or less than the total number of Character Units of authentication device and validated for predetermined rules if any. The Call optionally includes identification number of a Sub Variable Character Set of any level.

Chance of Breach: It is the probability of success on random trial to arrive at the correct password by a person other than USER or SERVICE PROVIDER within the number of chances. When the number of chances is unlimited, the chance of Breach becomes 1, however complex the password is. This includes cases where number of chances in an attempt is limited but subsequent to a failed attempt, the password is unchanged and hence it is equivalent to unlimited number of chances.

Character Unit (CU): It is the basic unit of Variable Character Set consisting of only one Basic Character or a permutation of more than one Basic Character. It is any random permutation of any type of Characters.

Encryption keys: These are used to encrypt objects exchanged in each transaction and are (i) the string formed by Call of random numbers for a transaction and (ii) Password for a transaction.

Human USER: Human USER is a USER who is a person.

Internet Contract Transaction (ICT): It is any Internet transaction, which has some monetary or other value between a USER and a SERVICE PROVIDER, using directly, the USER's account with that SERVICE PROVIDER or indirectly, using USER's account with any other SERVICE PROVIDER.

Master Variable Character Set (MVCS): It is a Variable Character Set defined for use in a system as the Master Variable Character Set, which contains all the Character Units of all Sub Variable Character Sets or from which many further Sub Variable Character Sets are derivable.

Maintaining link: It is to ensure the link between USER/USER Agent Software and SERVICE PROVIDER is unchanged from beginning to end of a session and both USER/USER Agent Software and SERVICE PROVIDER are the one and the same from beginning to end of a session.

Mutual authentication: It is to authenticate SERVICE PROVIDER and USER, using two different Passwords called by one to the other.

Network Transaction: It is any Local Area/Wide Area Network transaction, which has some monetary or other value between a USER and a SERVICE PROVIDER, using directly, the USER's account with that SERVICE PROVIDER or indirectly, using USER's account with any other SERVICE PROVIDER.

Non-Repeating Bilaterally Generated Variable Instant Password (NRBIGVIP): It is a Password which is generated using the Bilaterally Generated Variable Instant Password system in which, in any Password Call, a fixed number of Character Units out of the total number of Character Units of the Variable Character Set/Sub Variable Character Set of any level, forming a Password, are called for the first time in the span of use of the authentication device between two optional transformation/font/distinguishing property changes. The balance number of Character Units out of the total number of Character Units forming a Password only is/are repeatedly called and no Password repeats.

Number of chances: It is the permissible number of times of furnishing the correct Password in one attempt. Depending on the security requirement, it is kept as only one or two or three.

Objects exchanged between USER and SERVICE PROVIDER: The objects include Passwords, Calls, files or message packets generated in transactions individually or collectively, which are swapped between USER and SERVICE PROVIDER in Internet/Network transactions.

Password: It is a Password generated using the Bilaterally Generated Variable Instant Passwords system and is a Bilaterally Generated Variable Instant Password or Non Repeating Bilaterally Generated Variable Instant Password. It is a permutation of Character Units of the authentication device.

Password Safety Index (PSI): It is a number derived from the equation: 2^{(PSI)}=1/(Chance of Breach). It is to facilitate easy comparison between passwords and represents the safety of the password in terms of bit size of an equivalent encryption system.

Previously unknown USER: Previously unknown USER is a USER who is yet to establish an USER account with the SERVICE PROVIDER with whom USER wants to transact and includes temporary/short duration USERs excused from having an USER account.

Providing proof for a transaction: It is to preserve the Call and Password of each transaction as the proof of that transaction along with Internet Protocol address wherefrom USER transacted, date, time and USER's details, including Internet Protocol address of Internet Service Provider/Network Server who forwarded the request of previously unknown USERs.

Response: It is the answer furnished for a Call, in terms of Character Units of the authentication device, whose serial numbers of Character Units are the numbers called in the order of Call, typed as continuous string of Character Units, in which the Basic Characters are indistinguishable as belonging to particular Character Unit. When the Call includes identification number of a Sub Variable Character Set of any level, then the Response also includes identification number of that Sub Variable Character Set of any level.

SERVICE PROVIDER: SERVICE PROVIDER is a person or a process or software or specified sector(s) of data storage media or a system or server or a Network or any thing who/which provides access to the USER upon furnishing of valid Password to authenticate himself/herself/itself.

Sub Variable Character Set (SVCS): It is a Variable Character Set derived from Master Variable Character Set, it's Character Units are all from the Master Variable Character Set, and is identified for use by any one USER or any one category of USERs.

Sub Variable Character Set Level 2, Level 3 etc. (SVCSL2, SVCSL3): It is further derivation from Sub Variable Character Sets identified for use by any one-subgroup of USERs or any one-subgroup category of USERs. Its Character Units are all from one level up Sub Variable Character Sets.

Stronger Password: It is a Password, which has twice the normal number of Character Units in a Call, designed to test physical availability of authentication device with USER after a failed attempt.

Temporary authentication device: It is an authentication device sent by a SERVICE PROVIDER to a previously unknown USER through the Internet Service Provider/Network Server.

Transaction: It comprise of two consecutive exchange of objects between USER and SERVICE PROVIDER in which, one object is exchanged from USER to SERVICE PROVIDER and other object is exchanged from SERVICE PROVIDER to USER.

USER: USER is a person or a process or software or specified sector(s) of data storage media or a system or server or a Network or any thing who/which uses a Password to authenticate him/her/it.

USER object: USER object is a USER, other than a Human USER.

USER Agent Software: It is a specially designed software program, representing USER and transacting with SERVICE PROVIDER. It is integrated with Internet Contract Transaction/Network Transaction software or used as independent software. It functions from the USER's system to perform authentication of individual transactions, authentication and exchanging objects on behalf of the USER, checking for origination of USER's message from within USER's system and passing on the objects received from SERVICE PROVIDER to USER.

Variable Character Set (VCS): It is a list or table or array or matrix, which contains a selected number of Character Units. A serial number identifies each Character Unit.

List of Abbreviations/Symbols/Conventions Used:

BC Basic Character

BIGVIP Bilaterally Generated Variable Instant Password

CU Character Unit

ICT Internet Contract Transaction/Network Transaction

IP address Internet Protocol address

ISP Internet Service provider/Network Server

LAN Local Area Network

MVCS Master Variable Character Set

NRBIGVIP Non-Repeating Bilaterally Generated Variable Instant Password

SNCU Serial number of Character Unit

SVCS Sub Variable Character Set

PSI Password Safety Index.

VCS Variable Character Set

VLN Very large number exceeding 10³⁰⁷

WAN Wide Area Network

To indicate plural “s” is added to all abbreviations.

= Equal

+ Addition

− Subtraction

*or: × Multiplication

/ Division

ˆExponential

log N Logarithm of ‘N’ to the base 10

ⁿPᵣ Number of permutations of ‘r’ objects out of a total of ‘n’ objects

7.86E+07 7.86×10⁷ (Convention used for large numbers)

The terms ‘USER’ and ‘SERVICE PROVIDER’ with all letters capitalized are used, where the defined meanings are applicable. Where, ‘User’ or ‘user’ and ‘Service provider’ or ‘service provider’ or their plurals occur, they denote only the persons, who are seeking authentication or a person or system, accepting authentication. All other technical terms will have their defined meanings, throughout this description. In this description, excluding definitions, claims and abstract, wherever ‘Variable Character Set’ is written, it is to be read as ‘Variable Character Set/Sub Variable Character Set of any level’ and ‘VCS’ is to be read as ‘VCS/SVCS of any level’ unless the context indicates other wise. Definitions of USER, Human USER, USER object, SERVICE PROVIDER, Call, Response, Number of chances, Chance of Breach and Password Safety Index do not require further elaboration, as meanings are obvious from the definitions.

Bilaterally Generated Variable Instant Password System:

The Bilaterally Generated Variable Instant Password System is an authentication system that integrates functions of authentication and securing of transactions, authenticated Call initiation, USER Classification on access and is also capable of functioning as an independent symmetric encryption key system. The system authenticates USERs, SERVICE PROVIDERs, each one of the transaction initiated by USERs and each one of the object exchanged in transactions. The system provides two different computationally non-intensive, symmetric encryption keys linked with USER's identity to each one of the transactions, for securing transactions of USERs. The authentication and securing of individual transactions is done for known USERs, as well as previously unknown USERs. The system is designed to generate plurality of Passwords, from single initially furnished Password, relieving USER from further input, to authenticate and secure every Internet/Network transaction. The system provides a computationally non-intensive means of tracing objects to the originator. The system dispenses with memorization. BIGVIP system uses the Variable Character Set System of authentication devices. The system encompasses the authentication process, the authentication system and interface programs executable by SERVICE PROVIDER/USER systems. The system is capable of generating two types of Passwords namely Bilaterally Generated Variable Instant Passwords and Non Repeating Bilaterally Generated Variable Instant Passwords.

The system is suited to mutual authentication. The objects exchanged in Internet transactions are access restricted to specific USER or SERVICE PROVIDER at the respective IP address. Continuity of the link between USER and SERVICE PROVIDER is ensured preventing clandestine diversion of link or substitution of USER/SERVICE PROVIDER. Generating multiple Passwords from single initially furnished Password, is a special method of the present invention, adopted to relieve USERs from furnishing many Passwords required to authenticate each transaction. The system is designed to authenticate every individual transaction of Previously Unknown USERs by using a temporary authentication device. A method of access control using the system, suiting all types of SERVICE PROVIDERs is disclosed. The system by its inherent strength is able to substitute Biometric authentication avoiding repeated use of Biometrics. The use as an independent symmetric encryption key system does not involve exchange of keys. A direct and computationally non-intensive Call initiation method using the system is disclosed. Automatic classification of USERs on access is designed using the system to relieve USERs from furnishing additional data, every time USERs seek access to controlled sub domains.

The system is designed to perform a number of authentication and transaction security based tasks, which include, but not limited to:
1) Authentication of USERs including persons and objects to protect Networks, computer systems, data, software, hardware, camera, mobile phone, and similar devices, and access restriction of USERs to the level of specified sector of data storage media, including substituting Biometric authentication. Authentication includes mutual authentication of SERVICE PROVIDER and USER
2) Capable of functioning as an independent symmetric encryption key system
3) Two way authentication and securing by encryption of each and every individual Internet Contract/Network transactions of USER with different Passwords, furnished by a USER separately for each transaction, inclusive of objects exchanged between USER and SERVICE PROVIDER using one Password furnished by USER and one system generated, as Passwords/encryption keys for each transaction, including maintaining link between USER and SERVICE PROVIDER from beginning to end of session.
4) Two way authentication and securing by encryption of each and every individual Internet/Network transaction inclusive of objects exchanged, by different variable Passwords with just one Password furnished by a USER at the beginning of a session, using a specially designed USER Agent Software, by using two system generated Passwords/encryption keys for each transaction including maintaining link between USERs and SERVICE PROVIDERs from beginning to end of session and providing proof for all transactions of USER.
5) Two way authentication and securing by encryption of each and every individual Internet/Network-transaction inclusive of objects exchanged of a previously unknown USER with different Passwords, generating said different Passwords from one Password furnished from a temporary authentication device, by previously unknown USER at the beginning of a session using a specially designed USER Agent Software using two system generated Passwords/encryption keys for each transaction including maintaining link between previously unknown USERs and SERVICE PROVIDERs from beginning to end of session and providing proof for all transactions of previously unknown USER.
6) Authenticated dialogue initiation in Internet/network, providing means of verification as to the party seeking access to a system is the party called, facilitating grant of preferred access to called parties and denial or providing non-preferred access to uncalled/uninvited parties, even when the party is unknown to the USER
7) Automatic classification of USERs on access, dispensing with requirement on USER to furnish details before access to controlled sub domains of a SERVICE PROVIDER to reduce one or more stages of communication.

To appreciate the invention properly, the disclosure is arranged in the following order: the system of authentication devices, authentication process, two types of Passwords generated, methods used in authentication, system characteristics, advantageous effects of the invention, modes of carrying out the invention and industrial applicability.

Variable Character Set System of authentication devices: In Bilaterally Generated Variable Instant Password System, the Variable Character Set System of authentication devices are used as means of generating variable and instant Passwords by authorized USERs and as means of verifying the variable and instant Passwords by SERVICE PROVIDERs providing access and service to the USERs. They are:

1) Variable Character Sets (VCS)

2) Master Variable Character Sets (MVCS)

3) Sub Variable Character Sets (SVCS)

4) Sub Variable Character Sets of Level 2 or below (SVCSL2, SVCSL3 . . . )

The system has the following subsystems:

1) VCS for both SERVICE PROVIDER and USER.

2) MVCS with a SVCS expressed in brief form for SERVICE PROVIDER and a SVCS for USER.

3) MVCS with a SVCSL2 or below expressed in brief form for SERVICE PROVIDER and SVCSL2 or below for USER.

Any one of the three subsystems is used according to choice of SERVICE PROVIDER or the type of use. All the authentication device mentioned above comprise of an arrangement of a plurality of Character Units (CUs) in which the CUs are identified using unique Serial Number of Character Units (SNCUs). The arrangement is designed to obtain different variable Passwords formed of all permutations of a selected number of CUs in which the CUs could repeat within a Password. The CUs consist of either one Basic Character (BC) or a permutation of more than one BC.

Basic Character: The basic elements of VCS are the characters used to form CUs. Hence, they are called Basic Characters (BCs). They are single characters selected from any type of characters like Alphabets, Numbers and Symbols of any language or script or number or symbol systems identifiable by USER and SERVICE PROVIDER, with or without any font/distinguishing property such as font type, font size, font colour, Underlined, Bold, Italics, etc. Any representation of objects like diagrams, drawings, images, photos, pictures, sketches, identified as distinct units, with or without any distinguishing property identifiable by USER and SERVICE PROVIDER such as size, colour patterns, shading, Underlined, etc, are also used as BCs.

BIGVIP System recognises each of the characters distinctly based on font/distinguishing properties of characters. Each BC is formed in a calculated number of ways, which is the product of the number of characters used, and number of each one of the font/distinguishing properties used. If 20 font colours, 20 font types, 10 font sizes, Underlined/Non underlined characters are used, a single BC is formed in 20×20×10×2=8000 ways. Without font/distinguishing property variation, it is only one way. Human USERs could recognise some variations in font/distinguishing properties like font colours, Underlined characters easily. Human USERs, only with prior knowledge, could recognise/do variation in font types, Italics, Bold, and font sizes. Some of the font types are written similar to Italics. Large font size is undifferentiated, whether it is Bold or otherwise. Therefore, font/distinguishing properties, which are difficult to recognise, is brought to the prior knowledge of Human USERs. Alternatively, these font distinguishing properties are chosen by Human USERs; for example, in a Password, the first character's font type is set to Arial, second character's size is set to 16, third character's is Bold, fourth character is in Italics, or all CUs in the first row will have Arial font, all CUs in the second row will be of size 16, etc. USER objects are able to recognise any font/distinguishing property variations, when programmed and hence use of font/distinguishing property variations is unrestricted and the allowable variation is much larger. Differentiation based on font/distinguishing property variations in non-computer systems like cameras, mobile phones, etc is usable when such hardware are able to differentiate between same characters based on font/distinguishing property. The differentiation based on font/distinguishing property variations is done to the extent the USER/SERVICE PROVIDER are able to recognise and use.

USERs without being conversant with a language or number system, use characters from that language or number system, as CUs are seen from VCS and furnished by Human USERs. Scroll/drop down menus, which are unrestricted by any character selection algorithm for choosing characters and changing the font/distinguishing properties and offer freedom to select any character/font/distinguishing properties, facilitate Human USERs to furnish the BCs, easily. For USER objects, recognition of any type of character or font/distinguishing properties is programmable. Since forming of CUs is random process, some of the BCs that were originally used to generate CUs are feasibly excluded, from all the CU of a VCS. Even if a few BCs are feasibly excluded in the CUs of a VCS, still for calculation of chance of breach and PSI, the number of BCs used initially to generate CUs only is taken in to account. The total number of BCs required is decided to ensure the number of permutations of BCs forming unique CUs and number of permutations of CUs forming unique VCSs are sufficient to cover the safety requirements of Passwords and the requirement of unique VCSs for all USERs of a SERVICE PROVIDER. The BCs are selected directly from characters with or without font/distinguishing properties or indirectly by selecting characters and selecting font/distinguishing properties separately and arriving at every possible combination of each of the characters and each of the font/distinguishing properties. This completes selection of BCs. The following is to be taken care: When using numbers and alphabets as BCs, every BC is to be written or printed in unique way and there is no confusion in reading from the VCS. The characters: C, c, I, l, 1, K, k, o, O, 0, P, p, S, s, U, u, V, v, W, w, X, x, Y, y, Z and z, are a few, which could be wrongly read.

Example of BCs: A, e, 1, 9, &, @, $, A, e, 1, 9, &, @, $, A, e, 1, 9, &, @, $. Even though same set of Characters are shown 3 times, they are differentiated based on font/distinguishing properties ((Arial font, 10 size, Black, Bold), (Times New Roman font, 12 size, Grey-80%, Italics), (Courier New font, 11 size, Grey-50%, Underlined)) and hence each BC is unique. Examples for font property variations of BCs are given in VCS 5 to VCS 6. Use of large number of BCs with characters from 3 languages, 2 number systems, symbols and pictures to give an idea of possible variations of BCs is shown in VCS 6.

Character Unit (CU): CUs provide variability to Passwords. It is the basic unit of VCS made of only one BC or a permutation of more than one BC. It is any random permutation of any type of BCs. The advantage of multiple character CUs is that USER has to refer to VCS to get CUs less frequently as compared to single character CUs; (for 6 characters Password, in case of single character CU, USER has to refer to VCS, 6 times but with 2 BCs per CU, USER has to refer to VCS, only 3 times). Higher the number of BCs per CU, higher is the number of possible ways of forming CUs and number of possible ways of forming unique VCSs. Generally, CUs in a VCS have a fixed number of BCs. However, it is permissible to use a limited number of CUs (up to 10%) with less number of BCs per CU, i.e. in a VCS, which has mostly CUs of 3 BCs, it is allowed to use CUs of single or 2 BCs up to 10% of total number of CUs. This method further enhances variability of CUs. VCS 2 and VCS 4, illustrate this.

Method of generation of CU: The steps are: BCs and the number of BCs per CU are selected in a way convenient to USER to read and reproduce at the time of Password generation. The number of CUs in a VCS is selected, ensuring the resulting number of permutations of CUs forming unique VCSs and the total number of Passwords generated from the VCS meets the requirement of USER and SERVICE PROVIDER. The mathematical relationship between BCs, CUs, VCS, Passwords and PSI is taken in to account in selection of BCs and BCs per CU. The CUs are generated by random choice of single BC-CUs or random permutation of multiple BC-CUs using all the BCs selected. The random permutation includes repeating a BC within same CU.

For example, say: A to Z, without font/distinguishing property variations are chosen as BCs. Each BC is assigned a serial number (say 1=A, 2=B, 26=Z). The number of BCs per CU is decided. Using a program, random numbers within the total number of BCs are generated (say 24, 3, 13,7,19,5,22, 1,9,9 etc.) For single BC-CUs, the random numbers are replaced with BC corresponding to the assigned serial number, which become the CUs (for above serial numbers, the CUs are X, C, M, G. S, A, I, I, etc.). Two, single BC-CUs as obtained in previous step are combined to get 2 BC-CUs (for above serial numbers, the CUs are XC, MG, SA, I I, etc.). Similarly any number of CUs with any number of BCs per CU is formed. Examples: 7, D, 43, Sf, 1A$, 927, sR6@, a7B8*, 7, D, 43, Sf, 1A$, 927, sR6@, a7B8*. Even though, same characters or character strings are shown, 2 times in the above example, they are differentiated based on font/distinguishing properties and hence each of the above CU is unique. For more examples of CUs, VCS 1 to VCS 6 may be referred to.

Variable Character Set (VCS): It is a list or table or array or matrix, which contains CUs. It is generated either by USER or by SERVICE PROVIDER. It is known only to USER and SERVICE PROVIDER, with exception in special uses to identify unknown parties, when it is made public or routed through ISP. VCS has a large number of CUs. Each CU is identified by a unique serial number of CU (SNCU). For USERs to generate CUs/VCS, SERVICE PROVIDER specifies rules or USERs combine BCs in any manner, which is validated for randomness and accepted by SERVICE PROVIDER. If VCS is in rows and columns, SNCUs have to be assigned in a manner, which facilitates easy identification/calculation by USER for USER to read CUs corresponding to SNCUs. In VCSs, no relationship exists between CUs and SNCUs. Similarly no relationship exists among the CUs, because CUs are randomly generated. Non existence of such relationships, prevent shoulder surfers from extrapolating other CUs. VCS are very simple such as VCS 1 to VCS 4 or complex such as VCS 5 and VCS 6. The choice of complexity of VCS is to be decided by SERVICE PROVIDERs according to the requirements and preference of Human USERs. If a VCS is safeguarded, it is useable for a very long time without replacement. Also, creation of VCS is a simple process, even if there is a need for replacement. VCS is printed on a physical medium such as paper and if required in encrypted file form stored in a memory device for USER. SERVICE PROVIDER stores the VCS in digital form and/or similar means using a memory device. For systems like Camera, VCS is embedded.

Method of generation of VCS: The number of CUs, in a VCS is decided based on requirements of USERs, the type of Passwords (Repeating or Non Repeating), the number of CUs in a Password and PSI. The CUs, generated by following method given under Method of generation of CUs, are arranged sequentially or randomly. The required number of CUs are arranged to any one of the form of list or table or array or matrix suitable to USER to get VCS. Each CU is assigned a unique serial number. The method of identifying/calculating the serial number also is specified.

Examples of VCS, viz: VCS 1 to VCS 6 are given in Table I to III. VCS 1 to VCS 4 are simpler type. VCS 5 shows font/distinguishing property variations of characters. VCS 6 is made of characters from 3 languages, 2 number systems, a number of symbols and pictures to show possible variations of VCSs. The characteristics of the VCSs are explained under Characteristics of BIGVIP System.

Master Variable Character Set (MVCS): It is a large VCS defined for use in a system as the Master Variable Character Set, which contains all the Sub Variable Character Sets (SVCS). Many VCS are derived from MVCS. The VCSs derived from MVCS are called SVCS. In case, USERs are allowed to create, SVCSs of their choice, then, MVCS is generated as combined, continuous and non-overlapping list of all SVCSs of all USERs in a system. MVCS is used as the principal authentication device for all USERs in combination with SVCSs, as means of generating variable and instant Passwords in the BIGVIP system as an alternative to individual VCSs, conferring substantial advantage to SERVICE PROVIDERs.

Method of generation of MVCS: The number of CUs are decided considering the requirements of all USERs, USER groups, the type of Passwords (Repeating or Non Repeating), the number of CUs per Password and PSI desired. It is generated following the same method of generation of VCS, except that large numbers of CUs are used. In case, USERs are allowed to create, the SVCSs, then, MVCS is generated as combined, continuous and non-overlapping list of all SVCSs of all the USERs in a system. Example: MVCS 1 is given in Table V.

Sub Variable Character Set (SVCS): SVCSs are used in combination with MVCS, as means of generating Passwords in the BIGVIP System as an alternative to individual VCSs, which confer substantial advantage to SERVICE PROVIDERs. They are identified for use by any one USER or any one category of USERs and are derived from MVCS if generated by SERVICE PROVIDER. Each SVCS has any number of CUs of MVCS arranged in any order. SERVICE PROVIDER defines the rules for framing SVCSs in terms of SNCUs of MVCS, similar to criteria for filtering records of a data table. In addition, discrete, continuous or random sequences of CUs of MVCS are used to form SVCS. SVCS have a few mutually non-exclusive CUs. The extent of non-exclusive CUs is limited in order that no specific relationship is established, between CUs of two SVCSs by comparing SVCSs of same origin. This way a large number of SVCSs are formed out of one MVCS. CUs are selected from MVCS, as given here and arranged in to get a SVCS. These rules are also programmed to get SVCSs. The CUs of SVCSs are assigned SNCUs independent of SNCUs of MVCS. A Serial number/identification number is assigned to each SVCS. Prefixing or suffixing identification number of the SVCS of MVCS with Password is used to identify any Password specific to a particular SVCS of the MVCS. In case, USERs are allowed to create, SVCSs, USERs create it in the same manner of creation of VCS. For USERs, there is no difference between individual VCS and SVCS functionally. SERVICE PROVIDER maintaining separate SVCSs in complete form is dispensed with. SVCS as a list of SNCUs of MVCS is only to be maintained. SERVICE PROVIDER specifies rules of framing SVCS in terms of SNCUs of MVCS or specifies only the SNCUs of MVCS for each SVCS. When SVCS is specified by rules, it is briefer than a VCS of equal size, exception being small SVCSs with too few CUs. When SVCS is specified by SNCUs of MVCS, it is mostly in sequences and each of such sequence is briefly indicated by just 2 SNCUs; In both cases SVCS are represented by unique SNCUs of MVCS, more briefly than a VCS of same number of CUs, exception being small SVCSs with too few CUs. USERs are given complete SVCS. The Password calls are in SNCUs of SVCS. When validating Passwords, the validating program compares with CUs of MVCS corresponding to the SNCUs of SVCS. Even if a SVCS is compromised or physically stolen, the MVCS is still unchanged and another SVCS is made out of the MVCS.

Example of Specifying SVCS by rules:

a) All CUs of MVCS, whose SNCUs are between 57 and 157 and are of even number,

b) All CUs of MVCS, whose SNCUs are between 39 and 88 and written in descending order,

c) All CUs of MVCS, whose SNCUs are between 47 and 295 and Modulus (SNCU, 5)=3, etc.

Example of generation of SVCS and Specifying SVCS by SNCUs of MVCS: MVCS 1 has been used to generate a few 50 CU, SVCS in the following manner.

| | | Number of |
|---|---|---|
| SVCS | SNCUs | SNCUs, which |
| Identification | forming SVCS | represent SVCS |
| AA | 1 to 50 | 2 |
| AB | 46 to 95 | 2 |
| AC | 91 to 140 | 2 |
| AD | 136 to 185 | 2 |
| AE | 181 to 231 | 2 |
| AF | 226 to 275 | 2 |
| AG | 271 to 300, 1 to 5, | 8 |
| | 75 to 80, 130 to 137, | |
| | 49, 167 | |
| AH | 183 to 192, 27 to 36, | 10 |
| | 254 to 263, 130 to 139, | |
| | 75 to 84 | |

And so on i.e.: many more are created. From the above examples it is inferred that SVCS is represented in a briefer way than a VCS of same number of CUs. It is also inferred that many SVCSs are derived from one MVCS with less than proportionate number of CUs required for all the SVCSs. The 8 SVCS shown in the example are shortly, represented by a total of 30 SNCUs of MVCS. Instead of storing 8×50=400 CUs, only 300 CUs and 30 SNCUs need be stored, which shows the possible reduction of data storage. With many more possible SVCSs, the high advantage of using MVCS/SVCS arrangement is obvious.
Sub Variable Character Set of Level 2 or below (SVCSL2, SVCSL3 . . . ): SVCSs of level 2 or below are also used in combination with MVCS, as means of generating variable and instant Passwords in the BIGVIP system as an alternative to individual VCSs, which confer substantial advantage to SERVICE PROVIDERs. It is further derivation from SVCS identified for use by any one-subgroup USER or any one-subgroup category of USERs. This way large number of USERs with subgroup and subgroup of subgroups are formed. SVCSs of level 2 or below are derived from one level up SVCS and are any combination of parts of one level up SVCS. For SERVICE PROVIDERs, deriving SVCS of level 2 or below from one level up SVCS is similar to deriving SVCS from MVCS. USERs optionally select randomly, the required number of CUs, out of CUs of one level up SVCS provided by SERVICE PROVIDERs. SERVICE PROVIDER maintaining separate SVCS of level 2 or below in complete form is dispensed with. SVCS of level 2 or below as a list of SNCUs of MVCS is only to be maintained. SERVICE PROVIDER specify rules of framing SVCS of level 2 or below in terms of SNCUs of MVCS or only SNCUs of MVCS for each SVCS of level 2 or below. When SVCS of level 2 or below is specified by rules, it is briefer than a VCS of equal size, exception being small SVCSs of level 2 or below with too few CUs. When SVCS of level 2 or below is specified by SNCUs of MVCS, it is in sequences and each of such sequence are briefly indicated by just 2 SNCUs; In both cases a SVCS of level 2 or below are represented by unique SNCUs of MVCS, more briefly than a VCS of same number of CUs, except for small SVCSs of level 2 or below with too few CUs. USERs are given complete SVCS of level 2 or below. The Password calls are in SNCUs of SVCS of level 2 or below. When validating Passwords, the validating program compares with CUs of MVCS corresponding to the SNCUs of SVCS of level g or below. Even if a SVCS of level 2 or below is compromised or physically stolen the MVCS/one level up SVCS is still unchanged and another SVCS of level 2 or below is made out of the one level up SVCS.
Combined Use of MVCS and SVCSs: A SERVICE PROVIDER, having large number of USERs, instead of registering large number of VCSs, at the rate of one per USER, registers one MVCS in his system and defines the rules for framing as many SVCSs required or specify only SNCUs of MVCS for each SVCS. As shown in the examples given above, many SVCSs are derived from one MVCS with less than proportionate number of CUs required for all the SVCSs. SERVICE PROVIDER maintaining separate SVCSs in complete form is dispensed with. SVCS as a list of SNCUs of MVCS is only to be maintained. Unique SNCUs of MVCS represent SVCS, more briefly than a VCS of same number of CUs, exception being small SVCSs with too few CUs. Therefore reduction of data storage from many VCS to one MVCS and as many SVCS represented briefly, is obtained by combined use of MVCS and SVCSs. SNCUs of separate VCSs are diverse, their referral, calling the values in to software programs etc., have to be different for each VCS. SNCUs of MVCS representing the SVCSs are unique. Referral, calling the values in to software programs etc., is same for all SVCSs. Each VCS also have to be defined in the software programs separately, devoting a few lines for each VCS. When SVCSs are used this is dispensed with. This facilitates easy identification of SNCUs or CUs of SVCSs, in software programs, with fewer lines of programs. It also is necessary for classification of USERs on access as explained elsewhere. Even when, USERs are allowed to create, SVCSs, MVCS/SVCSs arrangement is used so that facility of easy identification in programs and automatic classification of USERs on access is still available and data storage is only slightly increased. MVCS/SVCS arrangement is useful when separate identity and authentication is required to access specific sub domains within a domain. MVCS/SVCS arrangement is convenient for short time use spanning a session, in authentication of USER initiated actions/objects, linking with the identity of USERs. MVCS/SVCS arrangement provides advantage and convenience to SERVICE PROVIDER. However, Use of individual VCS or MVCS/SVCS arrangement is optional.
Combined Use of MVCS and SVCS of level 2 or below: Use of MVCS and SVCS of level 2 or below is similar to use of MVCS/SVCS and confers similar advantages, but for lower reduction in data storage.
Distinct features of VCS system of authentication devices: Unlimited combination of characters of any language or script or number or symbol systems of any font/distinguishing property or diagrams, drawings, images, photos, pictures, sketches, as much as feasible in the BCs and CUs of the authentication devices, is fully utilised. CUs have any type of character in any part of CU. CUs of the authentication device in printed form are identified using unique SNCUs combined with having no upper limit on SNCUs. The authentication devices are self sufficient to locate and read characters of Password and requirement of additional reading devices/graphical user interfaces is avoided. The Password characters are directly reproduced from the authentication devices. All the CUs have predefined number of characters, which remain unchanged and unaffected by algorithms.

Exclusive features include: the CUs of the authentication devices comprise of completely random characters. Memorization of CUs is dispensed with. The total number of CUs in the authentication device is unconstrained by memory and is beyond human memorizable level accordingly, the SNCUs are also beyond human memorizable level. The SNCUs identify corresponding CUs. No further relationship exists between CUs and SNCUs and no relationship exists among the CUs, preventing shoulder surfers from extrapolating other CUs. The authentication devices are free from algorithms/pattern forming methods, which require recalling and implementation of the said algorithms/pattern forming methods to produce password. These features relieve USERs from cumbersome procedures. The authentication devices are designed to produce a plurality of Passwords simultaneously or from single Password in quick succession to authenticate every transaction in a session. The authentication devices are designed to produce Passwords of chosen level of safety. The system of authentication devices provide for storing of a Master Variable Character Set and a Sub Variable Character Set of any level in brief form. This in turn provide advantages of reduced data storage, ease of identifying CUs in programs in terms of SNCUs of MVCS, unique representation of CUs of SVCS of any level, facilitating automatic classification of USERs on access, facilitating generation of several Passwords from single Password initially furnished by a USER for authentication of every individual Internet transactions.

VCS system of authentication devices have large variation of characters resulting in unbreakable Pass words. However to prevent even the rare chance of breaching, two methods are provided. They are:
1) Repeated variation of font/distinguishing properties in printed Variable Character Set system of Authentication Devices
2) Transformation of Variable Character Set system of Authentication Devices
   Repeated variation of font/distinguishing properties in printed Variable Character Set system of Authentication Devices: USER, optionally, proposes changes to font/distinguishing properties such as font type, size, colour, Underlined, Bold, Italics, patterns, shading, as means of differentiation between same characters of Password/CUs of VCS of any level in use, and SERVICE PROVIDER registers the changes. Alternatively, a SERVICE PROVIDER issues variation of font/distinguishing properties at regular intervals and USER agrees. USER uses a separate transparent sheet to the size of printed Variable Character Sets/Sub Variable Character Sets of any level, indicating font/distinguishing property variation. Willing USER memorizes changes. The changes are kept separately from VCS of any level. The changes are allowed at any time and any number of times. When font/distinguishing property variation is effected, the original characters of CU in the VCS remain the same but BCs and CUs become different. If ‘HX’ is an original CU, a font/distinguishing property varied CU could be ‘HX’. The VCS in physical form remains unaltered, but the VCS as authentication device gets changed and new CUs/VCS of any level in use is obtained. This flexibility of varying BCs and CUs retaining original characters enables, securing the VCS against compromise. It also provides safety that even a stolen VCS could not be used, as font/distinguishing properties altered are unknown to any one except the USER and SERVICE PROVIDER. It facilitates longer span of use of VCS retaining original characters. Same VCS are used in any number of SERVICE PROVIDERs also, with one set of font/distinguishing properties applied to CUs of VCS for each SERVICE PROVIDER.
   Transformation of Variable Character Set: It is an optional method, for deriving new CUs of VCSs instantly at the time of Response to a Call, by operating any rule or rules on a VCS by which the original CUs of a VCS becomes transformed to new CUs. This is used to secure VCS against theft or compromise, similar to varying font/distinguishing properties. Transformations are done on CUs or BCs. Few examples of rules of transformation are given below, using VCS1 as original VCS:
   SNCU of VCS (Transformed)=SNCU of VCS (Original)+27, for all SNCUs. Applying this rule on VCS1
   SNCUs of transformed VCS are {28, 29, 30, 31 . . . 97, 98, 99,100, 1, 2, 3, 4 . . . 24, 25, 26, 27 of VCS1}
   SNCU of VCS (Transformed)=(SNCU of VCS (Original)−10) for all SNCUs. Applying this rule on VCS1
   SNCUs of transformed VCS are {91, 92 . . . 99,100,1, 2, 3, 4 . . . 87, 88, 89, 90 of VCS1}
   When the SNCU of transformed VCS after operating the rule becomes negative, the total number of SNCUs of the original VCS has to be added to the figure to obtain the transformed SNCU. When it exceeds the total number of SNCUs of the original VCS, then the total number of SNCUs of the original VCS has to be deducted to the figure to obtain the transformed SNCU.

Transformation is also done on BCs. In this, the BCs are transformed by rules such as all ‘A’s are transformed to ‘E’, all ‘B’s are transformed to ‘F,’ all ‘C’s are transformed to ‘G’, etc.

For higher security, rules that are more complex or combination of rules are applied. The rules are changed at any time. Similar to font/distinguishing property variations, the transformation rules have to be registered with SERVICE PROVIDER and kept separately from original VCS. Willing USER memorizes the transformation rules. At the time of Response, USERs have to furnish CUs of transformed VCS from the original VCS by operating the pre-registered rules. Transformation rules are also specified by SERVICE PROVIDERs to be followed by USERs. Transformation is an additional safety measure, is used as a supplement to font/distinguishing property variation or independently.

Authentication Process: The process checks, “what the user has” to establish the authenticity. The USER and SERVICE PROVIDER use a pre agreed authentication device of VCS system of authentication devices, to generate Passwords. The Password comprises of a permutation of selected number of CUs of the authentication device. Optionally same CUs are repeated in Password. When a USER wants to initiate a transaction with a SERVICE PROVIDER, the USER approaches the SERVICE PROVIDER by opening the website or dialogue window or simply switching on a system. The SERVICE PROVIDER asks the USER to furnish the USER name or identification number such as credit card number. If USER name or identification number is unregistered, SERVICE PROVIDER reminds the USER to furnish correct USER Name and denies access after few chances. SERVICE PROVIDER after verifying USER name and referring to the pre agreed VCS for the particular USER, generates a specified number of random numbers each of which is equal to or less than the total number of CUs in the VCS and validates the random numbers for predetermined rules, such as non-repetition of random numbers. SERVICE PROVIDER then transmits the generated random numbers to USER, which is termed as a Call. The USER understands that these random numbers are SNCUs of the pre agreed VCS and USER has been called to furnish CUs corresponding to the called SNCUs, which is the Password for that transaction. USER's Response to this Call is by furnishing CUs whose SNCUs are the random numbers of Call, in the order of Call. The Password is furnished as a continuous string of CUs, combining all CUs of Password with BCs indistinguishable as belonging to particular CU of the authentication device. A Call could include identification number of a Sub Variable Character Set of any level. When Call includes identification number of a Sub Variable Character Set of any level, the Response also includes identification number of that Sub Variable Character Set of any level. The SERVICE PROVIDER verifies that each CU/SVCS Identification number furnished by the USER is correct and matches exactly as per the pre agreed VCS corresponding to the Call. When it is matched, the USER is authenticated. Otherwise, the USER is given a few more chances to furnish the correct Password. When USER fails, to furnish the correct Password within given chances, the transaction is aborted and subsequent attempt to take place only after specified time and the USER is to furnish 2 Passwords successively or equivalent stronger Password, entered in first chance itself to get authenticated. In case the USER is unable to furnish Password in a double Password Call or double strength Password Call at first chance, the USER is denied access until USER establishes his authenticity to the satisfaction of the SERVICE PROVIDER through other means.

Example of an authentication dialogue in Internet, between a USER, say USER1 and SERVICE PROVIDER say SP1, (who have pre agreed on VCS1) is given below:

USER1 has opened the website of SP1, indicating his desire
to do transaction and approached SP1.

| | |
|---|---|
| SP1: | Please enter your USER name |
| USER1: | USER1 |
| SP1: | 70, 31, 43 |
| USER1: | @xlmrA |
| SP1: | Welcome “USER1” (Welcome implies |
| | that USER1 has furnished the correct Password) |

Example of an authentication dialogue in Internet, between USER1 and SP1 when USER1 commits mistakes in furnishing CUs, rejected after 3 chances and after specified time reattempts:

USER1 has opened the website of SP1

| | |
|---|---|
| SP1: | Please enter your USER name |
| USER1: | USER1 |
| SP1: | 4,100,43 |
| USER1: | ZADJRA |
| SP1: | The Password you furnished is incorrect. |
| | Please enter the correct Password for 4,100,43 |
| USER1: | zadjra |
| SP1: | The Password you furnished is incorrect. |
| | Please enter the correct Password for 4,100,43. |
| | Reminder: Last Try. |
| USER1: | ZaDjRa |
| SP1: | Sorry. You have furnished incorrect Password thrice. |
| | ACCESS DENIED. You may retry after 2 hours. |
| | USER1 after 2 hours has opened the website of SP1. |
| SP1: | Please enter your USER name |
| USER1: | USER1 |
| SP1: | 71, 34, 85, 29, 96, 52. |
| | Reminder: Only one chance is allowed. |
| USER1: | FmOvclwlb1xP |
| SP1: | Welcome “USER1” (Welcome implies that USER1 |
| | has furnished the correct Password) |

Example of an authentication dialogue when using SVCS identified as AA {page 17} of MVCS 1 {Table V}, is given below:

USER1 has opened the website of SP1.

| | |
|---|---|
| SP1: | Please enter your USER name |
| USER1: | USER1 |
| SP1: | 19, 44, 13, Id. of SVCS |
| USER1: | VFRU64AA |
| SP1: | Welcome “USER1” (Welcome implies that USER1 |
| | has furnished the correct BIGVIP) |

Thus a Password is formed in an easy manner, using simple means of VCS. The Passwords are variable based on combination of random numbers for every transaction. They are also generated just at the instant of transaction.

Bilaterally Generated Variable Instant Passwords: It is a Password, generated using the BIGVIP System. In BIGVIPs, any CU is called repeatedly; i.e. any SNCU that has been called previously for a Password is called repeatedly for subsequent Passwords without any restriction. BIGVIPs repeat rarely. When VCS1 is used, on a 6-character Password chance of repetition is 1 in a million. Chance of repeating a Password is equal to that of any other variable Password of same Basic Characters. Therefore, it remains unused even when stolen, as none could predict, when the same Password will be called for, again. Repeated variation of font/distinguishing properties of VCS/Transformation of VCS is done optionally at any time and any number of times after the VCS is issued.

Method of generation of BIGVIP: SERVICE PROVIDER's and USER should have a data processor loaded with software implementing the system/methods connected by communication network to generate BIGVIP. In case of system like camera, embedded software in the SERVICE PROVIDER's system generate BIGVIP. SERVICE PROVIDER's program, calls for random numbers within the total number of CUs of the VCS and validates the random numbers for predetermined rules specified. After furnishing of BIGVIP by USER, it compares, admits or rejects authentication attempts. It limits the number of chances and Call for two BIGVIP successively/stronger Password, when there is a failure from USER to furnish Password within specified number of chances. It also furnishes report of all Password calls with time and failed attempts. It validates and accepts font/distinguishing property variations/Transformations done by USER.

Non-Repeating Bilaterally Generated Variable Instant Password (NRBIGVIP): It is a Password, generated using the BIGVIP system in which no Password repeats. In a BIGVIP, any CU that has been called previously for a Password is called again for subsequent Passwords without any restriction. In a NRBIGVIP, there is some restriction on calling CUs repeatedly. In each Call of NRBIGVIP, a fixed number of CUs (say 2 out of 3 CUs) have to be called for the first time. The balance (say 1 out of 3) only to be repeated. In case SVCS identification is required, it is also called for, along with CUs similar to BIGVIP. It is to prevent spying for CUs. With NRBIGVIPs, even when some body knows a number of CUs of the VCS of a USER, still will be unable to furnish the Password. These Passwords are used up before anybody attempts to steal. Thus NRBIGVIP is a still more secure Password. Font/distinguishing property variations are effected/Transformation is done in NRBIGVIP also, after issue of VCS. The VCS exhausts as and when the last CU that has to be called for the first time is called. After Font/distinguishing property variations/Transformation, the CUs/VCS become new.

Method of generation of NRBIGVIP: SERVICE PROVIDER's program is similar to BIGVIP with following additions: It maintains a list of already called SNCUs against each VCS, compares/limits the SNCUs to be repeatedly called and Calls for random serial numbers from the yet to be called list. It reports well in time, the exhausting of VCS so that replacement is arranged or USER is prompted to vary font/distinguishing properties of CUs/Transformation of VCS.

Methods Used in Authentication:

Generating multiple Passwords from one Password: This is a special method designed to relieve USERs from furnishing many Passwords for authenticating every transaction. The authentication device has same number of BCs per CU for all CUs to facilitate identification of CUs directly from Password. The Call is for a minimum of 4 CUs to ensure that at least 60 unique BIGVIPs are formed out of SVCS/SVCS L2, using 2 CU, 3 CU and 4 CU calls with different permutations at random. The method of generating multiple Passwords from single Password uses an USER Agent Software. The USER Agent Software collects the Call and Password for initial access from USER. From the Call and Password, number of CUs in the Password and CUs are determined. USER Agent Software then forms a SVCS of any Level, using all CUs as obtained above. Then it assigns SNCUs. SNCUs are communicated to SERVICE PROVIDER using the Password as obtained above as encryption key. When the first unexposed Call is used as SNCUs, the assignment of SNCUs and communication is avoided. The same procedure is adopted for temporary SVCS also. The SVCS of any level, so formed by USER Agent Software is used as the authentication device of that session. All Calls are made within the authentication device of that session. An example of this method is given below using VCS 3.

| | |
|---|---|
| SERVICE PROVIDERs Call: | 51, 133, 27, 150, 48, 44 |
| USER's Response (Password): | AmRQ5o |

| | | | | | | | |
|---|---|---|---|---|---|---|---|
| SVCS formed: | SNCU | 16 | 37 | 58 | 79 | 100 | 121 |
| | CU | A | m | R | Q | 5 | o |

The SNCUs are assigned here independently and communicated to SERVICE PROVIDER. When SERVICE PROVIDER's Call is unexposed, then 51, 133, 27, 150, 48, 44 are useable as SNCUs.

Example of Calls within SVCS: (i) 79, 16, 58, 100 (ii) 121, 37, 16 (iii) 79, 37 (iv) 16, 58, 100, 79, 121, 37

Responses: (i) QAR5 (ii) omA (iii) Qm (iv) AR5Qom

The above SVCS is capable of providing 1950 unique Passwords. Additional 1949 unexposed Calls are also available to secure objects exchanged in the transactions, making 3899 encryption keys/Passwords from this SVCS.

USER Agent Software: USER Agent Software: USER Agent Software is specially designed software, representing USER and transacting with SERVICE PROVIDER. It is integrated with Internet Contract/Network Transaction software or used as independent software. It functions from USER's system to perform authentication of individual transactions. This agent/software is assigned a temporary, session USER name as IP address of the computer, where from, USER accesses SERVICE PROVIDER. IP address of USER and USER's agent is the same. It performs all authentication and securing related tasks as detailed in the ICT authentication methods.

Mutual authentication: This feature is used to check whether USER is transacting with the same SERVICE PROVIDER with whom USER intents to transact or it is the same SERVICE PROVIDER as was at the beginning of the session or the connection has been diverted to somewhere else. USER desiring to ascertain the authenticity of SERVICE PROVIDER, at any time after USER authentication, by pre arrangement, issues a Call. SERVICE PROVIDER provides Response. USER verifies the Response, with the authentication device and confirms the authenticity of SERVICE PROVIDER, whereby USER and SERVICE PROVIDER are mutually authenticated. The pre arrangement mentioned here is only for USER, exercising the option of checking since Call and Response are done in the same manner by both SERVICE PROVIDER and USER. When the Password is transmitted by encryption, authentication of SERVICE PROVIDER could be done after USER identification itself.

Use as an independent symmetric encryption key system: The Passwords are useable as encryption keys in which keys are not to be exchanged. Since multitude of keys could be generated simultaneously or in quick succession using the authentication system and an authentication device, the problem of key changing and key management with large number of service providers and USERs is solved. The keys are computationally non-intensive and the system has wide adaptability to all uses of encryption. The advantage of the system is that even the inverse keys are a set of random numbers and when unexposed are used as encryption keys to secure transactions and objects exchanged in transactions.

Internet Contract Transactions/Network Transactions (ICT): ICT is any Internet transaction, which has some monetary or other value. As SERVICE PROVIDERs allot, USER accounts, USER names and VCSs, only after the USER accepts the conditions of contract, between USER and SERVICE PROVIDER, ICTs include any or all Internet transactions between USER and SERVICE PROVIDER, with a USER account. Temporary USERs who do not have direct account with a SERVICE PROVIDER still transact, using the account with ISP/Network Server after getting the request forwarded by ISP/Network Server. Transactions on credit card, debit card, bank transactions, share market transactions, buying, selling, payment, receipt, gift, bet, sending/receiving emails, accessing information in websites, downloading software or articles, sending or receiving data packets or files, are a few examples of ICTs. There are three methods of authentication of ICTs as detailed below:

Authentication of each individual transaction of Known USERs: In BIGVIP System, when required, authentication is done for each of the transaction (i) by obtaining Password from USER at the rate of one for each transaction. (ii) by generating multiple Passwords from one Password initially furnished by a USER. First method is used in automatic transactions between systems (USER and SERVICE PROVIDER are non-human), or the security of transactions require individual Passwords, directly from authentication device. Second method is used for all ICTs of established USERs other than specific cases covered in the first method.

Authentication of every individual transaction of previously unknown USERs: A previously unknown USER is a USER who is yet to establish an USER account with the SERVICE PROVIDER with whom USER wants to transact and includes temporary/short duration USERs excused from having an USER account. Examples: USERs before setting up an account, one time USERs like, participants in auctions. The system provides for a method to confirm the identity of a previously unknown USER from an ISP with whom that previously unknown USER has an USER account. A temporary authentication device and a Call are passed through the ISP, in an access-restricted folder after ISP authenticates the USER to SERVICE PROVIDER. Previously unknown USER is provided with the Password directly from SERVICE PROVIDER to open the access-restricted folder. The previously unknown USER opens the access restricted folder and furnishes Password to the Call sent to him, from when on the previously unknown USER becomes an authenticated temporary USER to that SERVICE PROVIDER. Then each one of the transactions of previously unknown USER are authenticated by generating multiple Passwords from one initially Password furnished from the temporary authentication device.

Securing Transactions and Objects exchanged in transactions: In BIGVIP System, Call is a permutation of random numbers and variable for every transaction. The string formed by Call of random numbers, is used as additional variable Password or encryption key. This is beneficially used to secure transactions in the following manner: In BIGVIP System the objects are exchanged in folders/packets containing unexposed Calls, Passwords and file or messages. The initial Call is sent in unencrypted form. The Password for the initial Call is used as the first encryption key. Using this, the first object exchanged is encrypted and sent. When mutual authentication is performed, the Call and Response of mutual authentication are available as additional encryption keys, before transactions start. When mutual authentication is not performed, the initial Password is used as encryption key for the first object exchanged in the first transaction. All subsequent Calls are sent in encrypted form and unexposed. Therefore, all Passwords, and all Calls other than initial Call are unexposed and useable as encryption keys, to secure every one of the transactions and objects exchanged in transactions. Two encryption keys are available for each transaction. Using the Call for a transaction for object exchange from USER to SERVICE PROVIDER and the Password for a transaction for object exchange from SERVICE PROVIDER to USER is a preferred option. However, Passwords and unexposed Calls are usable to secure any subsequent transaction. The choice of specific Call or specific Password from among the Calls or Passwords generated up to that transaction in a session for encrypting and access restricting a specific folder is by availability or by prior agreement between USER and SERVICE PROVIDER. Cryptographic methods of are used for encryption/decryption using keys produced by the system. The cryptographic method is pre agreed. A combination of encryption as well as access restriction is used, so that even when some one is in possession of decryption key, still the object is inaccessible. Since encryption keys and Password are at times, different, Password is tested separately with in the encrypted folder.

Access restriction and ensuring continuity of link: In Internet transactions, access restriction is done by ensuring IP address from which the USER/USER Agent Software or SERVICE PROVIDER are transacting, remains one and the same from beginning to end of session and by obtaining a variable Password known only to USER/USER Agent Software and SERVICE PROVIDER for each object exchanged from that IP address. The method of access restriction to specific IP address supports likelihood of masking of IP addresses, continuously changing of IP addresses, using proxy servers, or similar techniques. Access restriction to specific folder is also done when required.

Authenticated Dialogue Initiation: The VCS defined for this purpose has to be very large and published or hosted in a server. A USER intending to initiate dialogue with another party, issues a Call from the VCS defined for this purpose. The party at the other end furnishes Password and gets preferred access. The parties furnishing incorrect Password or not furnishing Password are not called for and could be blocked or granted non-preferred access at USER's choice.

Automatic Classification of USERs upon access: Service provider use MVCS/SVCS arrangement in Identification of SVCS called for as part of Password. Checking Password alone identify SVCS and subgroups. This facilitates on access classification of USERs without obtaining further input data from USER and referring to previously stored information.

Characteristics of Bilaterally Generated Variable Instant Password System

Relationship between BCs, CUs, VCS and Password characteristics: Sample calculations for VCS 1 to VCS 6, which details, the relationship between CUs, BCs, VCS and characteristics of BIGVIPs/NRBIGVIPs, are shown in Tables IV-A & IV-B. The method of calculation is explained below, using VCS1, duly indicating relevant column number of Tables IV-A & IV-B.

(Column 1 to column 7): Serial number, Serial number of VCS, BCs used to form VCS (for VCS1: A to Z, a to z, 0 to 9, @ and $), total number of BCs used (for VCS1: 64), Number of BCs per CU (for VCS1: 2), total number of CUs in VCS (for VCS1: 100) and number of CUs in a Password (calculation for a 4CU or 8-character Password is shown below).

(Column 8): Using 64 characters, with 2-BC per CU, number of unique CUs, that could be formed is the number of ways of choosing two single characters successively out of 64 characters, which is 64×64=4096, assuming characters are repeated in same CU. (i.e., when ‘R’ is a BC, ‘RR’ is a CU).

(Column 9): Number of possible 4-CU or 8-character unique Passwords using all CUs in VCS1, is the number of ways of choosing 4 CUs successively out of 100 CUs, which is 100⁴=1×10⁸, assuming CUs are repeated in Password.

(Column 10): When some one knows the BCs used for forming VCS1 and attempts to randomly create an 8-character Password, his chance of success is the inverse of number of ways of choosing 8 single characters successively out of 64 characters, which is 1/64⁸=1/2.81E+14.

(Column 11): When some one is allowed 3 chances, then chance of randomly breaching the Password is 3/2.81E+14=1/9.38E+13

(Column 12): Password safety index or PSI is log (9.38E+13)/log 2=46.

(Column 13 to column 14): When 3 CUs out of 4 are non-repeating, then number of full NRBIGVIP Passwords that could be generated from VCS1 is 100/3=33.

(Column 15): When some one knows one CU and the BCs used for forming VCS1 and attempts to randomly breach Password in 3 chances, his chance of success is 3/64⁶=1/2.29E+10

(Column 16): PSI is log(2.29E+10)/log 2=34.

(Column 17): Number of permutations of 100 CUs out of 4096 CUs is =⁴⁰⁹⁶ P₁₀₀, a very large number (VLN) exceeding the largest number, (1×10³⁰⁷) a computer is programmed to calculate or store. Therefore billions and billions of 100 CU, VCSs, which are unique, are formed, using 64 characters. Note: For VCS 5, with font/distinguishing property variations, the total number of BCs is calculated as follows:

For 64 BCs with 20 font types, 10 font sizes, 20 font colours, Underlined or otherwise, the number of ways of writing any single character is the number of ways of choosing one character out of 64 and number of ways of choosing each one of the font/distinguishing property, out of the number of possible ways choosing that font/distinguishing property, successively, is 64×20×10×20×2=512000 ways.

For VCS 6, with different level of font/distinguishing property variations, the total number of BCs is calculated as follows: For 64 BCs with 20 font types, 10 font sizes, 20 font colours, Underlined or otherwise is =512000 as calculated above. For 61 BCs with 10 font sizes, 20 font colours, Underlined or otherwise, the number of ways of writing any single character is 61×20×10×2=24400. Hence total number of BCs=512000+24400=536400.

From the above calculations and Tables I to VI B, the following relationship between CUs, BCs, VCS and Password properties are established.

Higher the total number of BCs, used for forming CUs, higher is the number of possible ways of forming unique CUs and VCSs, lower is the chance of breach and higher is the PSI.

Variability of BCs is more due to font/distinguishing property variations than due to characters used.

Higher the number of BCs per CU, higher is the number of possible ways of forming CUs and number of possible ways of forming unique VCSs.

Higher the total number of CUs in a VCS and higher the product of number of CUs in a Password and the number of BCs per CU (or number of characters in a Password), higher is the number of possible unique Passwords and higher is the PSI.

PSIs of BIGVIPs and NRBIGVIPs are incomparable as for NRBIGVIPs non-repeating characters are only taken in to account.

About 100 CUs are enough to generate a million or more unique Passwords. Even though one Password is used up for one transaction, BIGVIP/NRBIGVIP require less than proportionate number of characters.

The calculations are based on the assumption that the person attempting to breach, knows the BCs used for forming VCS. With large variability of BCs that are used in this system, it is impossible, for any one to guess the BCs and therefore it is impossible to breach these Passwords.

VCS is flexible for generating Password of any strength, i.e. by varying the number of SNCUs called, i.e., Passwords with any number of CUs or required PSI is designed and generated. Designable Password system is envisaged. The selection of BCs, CUs and forming of VCS or design is based on similar calculations.

Advantage of variation of font/distinguishing properties on BCs. CUs. VCS and Password characteristics: This is explained below by an example:

VCS 5, has same characters as VCS1 but font/distinguishing properties have been modified with 20 font types, 10 font sizes, 20 font colours and Underlined or otherwise. With this variation in font properties, number of ways of writing any single character is 8000. A comparison of properties of CUs, VCS and Passwords generated from VCS1 and those of VCS 5, as extracted from Tables IV A & IV B, is shown below.

| | VCS 1 | VCS 5 | Ratio |
|---|---|---|---|
| Number of BCs used for | 64 | 512000 | 8000 |
| forming CUs | | | |
| Total Number of CUs in VCS | 100 | 100 | 1 |
| Number of possible CUs | 4096 | 2.62E+11 | 6.40E+07 |
| Number of Characters in Password | 8 | 8 | 1 |
| Number of possible Passwords | 1.00E+08 | 1.00E+08 | 1 |
| using all CUs in VCS | | | |
| Number of Unique Passwords | 2.81E+14 | 4.72E+45 | 1.68E+31 |
| using all BCs | | | |
| Chance of 3 Random Trials | 9.38E+13 | 1.57E+45 | 1.68E+31 |
| on all CUs 1 in | | | |
| Password Safety Index (BIGVIP) | 46 | 150 | 3.23 |

It is seen that, the number of unique ways of forming CUs, VCSs, Passwords and PSI increase enormously and chance of randomly breaching an 8-character Password with font/distinguishing property variation is less than chance of breaching a 128-bit encryption system. Thus, variation of font/distinguishing properties on VCS confer enormous advantage of very high variability of Password characters (from the level of one, to the level of thousands of times), less number of characters are enough to produce a given strength of Password, high variability of CUs, and VCSs, safety and security to VCS against theft or compromise and flexibility for using with any number of SERVICE PROVIDERs.

Variability of Passwords of BIGVIP System: CUs provide the first level variability to Passwords, which is more than that is available in existing Dynamic passwords. Second level of variability to Passwords is provided by using some CUs with less number of BCs per CU. Same VCS is flexibly, used for generating Password of any strength, by just varying the random numbers of Call, which provides third level of variability to passwords. Fourth level of variability to Passwords is obtained by making the VCS itself a variable, using font/distinguishing property variations/transformation of VCS, as detailed above.

Flexibility of Passwords of BIGVIP System: VCS is used for any number of USER accounts with font/distinguishing property variations retaining the original characters. By varying the random numbers of Call, same VCS is flexibly used for generating Password of any strength. It has the flexibility of providing any number of Passwords with or without human intervention. It has the flexibility that it is used for any kind of USERs i.e. humans and objects. Therefore BIGVIP system is a highly flexible Password system.

Security of Passwords of BIGVIP System: Chance of breach is 1 for static passwords, about 1 in 10¹² for an 8 character Dynamic passwords, BIGVIP system have much lower chance of breach. Chance of breach is a fixed value (as number of characters is fixed) in dynamic password system but in BIGVIP system, it is at any chosen level. NRBIGVIPs are used up before anybody attempts to steal. BIGVIPs could not be easily abused even when stolen, as none could predict, when the same Password will be called for, again. With four levels variability of Passwords and large variation of BCs of Password, there is hardly any chance of breaching these Passwords. Due to font/distinguishing properties variation/transformation VCS are unknown to any one except USER and SERVICE PROVIDER. Since the system is self relying to provide encryption, complete security is available.

Cost of adopting BIGVIP System: In BIGVIP system, there is no expenditure to USER and very little additional expenditure to SERVICE PROVIDER towards additional data storage for storing VCS and the software to make a Call of random numbers, obtain and compare Passwords. It is marginally costlier to static password system but cheaper than existing Dynamic password systems/One-time password systems and Biometrics. USERs/SERVICE PROVIDERs save on cost of separate generation and communication of encryption keys for securing transactions.

Distinct features of BIGVIP System: Integrates many functions such as authentication and securing of transactions, computationally non-intensive Call initiation, USER classification and as a symmetric encryption key system. The system is usable for authentication of a USER for a session or for each transaction or for each object exchanged between SERVICE PROVIDER and USER in transaction. The system is self-reliant to secure each transaction and provides two different computationally non-intensive, symmetric encryption keys linked with USER's identity to secure each one of the Internet/network transactions of USERs. The string formed by Call of random numbers is designed to serve as variable Password/encryption key. Therefore, two different means for two-way authentication are possible using BIGVIP System. The system secures each one of the Internet/network transactions of previously unknown USERs in a similar manner to that of a known USER. The system is designed to generate many different Passwords, from a single Password initially furnished by a USER. This relieves USER from furnishing many Passwords, which are required to authenticate and secure every transaction and objects exchanged in every Internet/Network transaction. The system provides a direct and computationally non-intensive means of tracing objects to the originator providing definite proof for solving and Internet transaction related claims. Calling two Passwords or equivalent stronger Password in only one chance provides resistance to breaking and automatically notifies USER on failed attempts. It designed to test physical availability of authentication device with USER after a failed attempt. Resistance to breaking and alerting arrangement is in built in the system.

In the system, memorization is not required. The system has done away with the limit on total number of CUs in the authentication device imposable by memorization. The system has done away with the limit on Call of random numbers imposable by memorization. VCS system of authentication devices is used by the system. The Passwords are unique for each Call and there are no multiple possibilities. Therefore, validation of Passwords of BIGVIP System is only a comparison and is a computationally non-intensive. Multitudes of Passwords are generated simultaneously or in quick succession. When used as encryption key system, the key management is simple, the keys are computationally non-intensive and keys are variable for every object exchanged. Avoiding memorization, algorithms and difficult procedures in the system help in automatic generation of many Passwords without difficulty and facilitate transactions without human intervention. The system provides temporary authentication device for a previously unknown USER generating variable passwords to authenticate previously unknown USER. The system facilitates authenticated dialogue initiation providing direct and computationally non-intensive means of verification as to the party seeking access to a system is the party invited for dialogue even when the party is unknown to the USER. The system facilitates identification of USERs as belonging to a particular group and classification of USERs to facilitate direct access to sub domains dispensing with the need of USERs, furnishing any data. The system generates Passwords of any required level of safety. User includes persons and objects. The system is usable in non-computer systems such as camera, mobile phone. Mutual authentication is feasible after USER identification and SERVICE PROVIDERs are optionally authenticated any time during a session, any number of times.

### ADVANTAGEOUS EFFECTS OF THE INVENTION WITH REFERENCE TO BACKGROUND ART

In BIGVIP System, no separate securing system is required to secure transactions after authentication. ICTs authentication and securing of each one of the transactions with multiple Passwords generated out of single Password USER input, from known and Unknown USERs is a special feature unavailable in prior art. Authenticated Dialogue Initiation which is computationally non-intensive is another feature unavailable in prior art password system. Automatic Classification of USERs upon access without obtaining additional data from USERs is yet another useful feature which is unavailable in the prior art password systems. Availability of computationally non-intensive, symmetric encryption keys at the rate of two for each transaction and the usability as an independent symmetric encryption key system with many advantageous features of BIGVIP system is unavailable in prior art.

For Password generation, no separate software is required at both ends. No special hard ware device also is required at USER end. No requirement of battery, initialization, unlocking, resynchronization, etc. There are no algorithm and input variables for generation of Password. No relationship between successive Passwords exists in BIGVIP system. There is no secret part of the password like in one-time passwords/Dynamic passwords. In BIGVIP system, Passwords with any number of characters are produced, that too, without any additional arrangements. There is no need of a separate validating password server. No need of synchronising USER and SERVICE PROVIDER. Except for wrong Response of furnishing CUs, there is no chance that authentication will fail. Need of PIN memorization and entering PIN, every time a password is to be generated is dispensed with. No need to copy down password from special hardware device to system requiring passwords. Validation is computationally, non intensive as it is just a comparison. Same VCS is used in any number of SERVICE PROVIDERs also, with just font/distinguishing property modifications. No need of alternate communication channels to transmit passwords and no expenditure on additional communication channel. No fear of loosing password in transit, no delay, no problem of non-receipt of password. Any number of passwords are generated instantly and hence there is no need to use one password for multiple transactions.

They are better than printed One-time passwords as there is no need of USER and SERVICE PROVIDER to keep track of each password used. There is no need of frequent replacement of password card and re-registration of passwords. Even NRBIGVIP, with 6-character password and 4 characters non-repeating, requires 100 characters for 25 passwords, whereas printed One-time passwords require 150 characters. Password is instantly generated and impossible to abuse, even when VCS is stolen, as font/distinguishing property variability of VCS is unlimited. BIGVIP system is less expensive than Dynamic password Systems. BIGVIP system offers highest flexibility of use. BIGVIP system is useable in high value Internet contract transactions or access control to high security Networks and for any one or any thing, requiring authentication. The economy, variability, flexibility and security of passwords of BIGVIP System are unavailable in any of the existing dynamic password systems. BIGVIP System substitute Biometric authentication avoiding repeated exchange of biometric data in Internet with less cost and no fear of theft of biometric data.

### BRIEF DESCRIPTION OF DRAWINGS/TABLES

Table I, in Page 41, shows VCS1 to VCS 4. Table II, in Page 42, shows VCS 5.

Table III, in Page 43, shows VCS 6. VCS1 to VCS 6 are Variable Character Sets and provide examples of Basic Characters, Character Units.

Table IV-A and Table IV-B, in Page 44 and 45, show the relationship between Basic Characters, Character Units, Variable Character Sets and Passwords for VCS1 to VCS 6.

Table V in Page 46, shows MVCS 1, example of Master Variable Character Sets.

Figures to illustrate different types of authentication and securing of Internet transactions are appended.

FIG. 1 is a flow chart of method of authenticating and securing of every Internet Contract/Network Transaction of a USER, in which USER has to furnish Password for every transaction.

FIG. 2 is a flow chart of method of authenticating and securing of every Internet Contract/Network Transaction of a USER, in which USER need to furnish only one Password at the beginning of a session.

FIG. 3 is flow chart of method of authenticating and securing of every Internet Contract/Network Transaction of a previously unknown USER, who/which need to furnish one Password from a temporary authentication device at the beginning of the session.

### MODES OF CARRYING OUT THE INVENTION

Method of authentication and access restriction of USERs: Authentication and access restriction of USERs to protect Networks, computer systems, data, software, hardware, camera, mobile phone, and similar devices, to the level of specified sector of data storage media, using Bilaterally Generated Variable Instant Password system is characterised by ability to optionally control access, object wise/transaction wise. Access restriction of USER is done to the level of specified sector of data storage media by defining the boundaries of SERVICE PROVIDER. The method includes system programs executable by SERVICE PROVIDER systems to which access is controlled. The Passwords are designed to the required level of security suiting SERVICE PROVIDER and USER. At least one Variable Character Sets for each access control module, optionally another for authenticating and allowing access to USERs and other to provide for eventualities, such as loss of Variable Character Set, transfer of ownership or similar situations, for the owner/manufacturer/system administrator to bypass the USER's Password, are defined. The second Variable Character Set is to be used after the owner/manufacturer/system administrator is legally permitted. The software or software controlling hardware for hardware is designed to form initially and modify subsequently, the Variable Character Sets. The design provides for USER requiring authentication of SERVICE PROVIDER, to issue a Call and SERVICE PROVIDER to respond. Where required, methods of Internet Contract/Network Transactions authentication and Authenticated Dialogue Initiation for Internet/Network based uses are built in to provide more effective protection from malicious attacks and other harmful effects. Access is granted for USERs and by option to individual session/transactions/objects initiated by USERs after authentication by a Password and access provided is restricted to specific SERVICE PROVIDER.

Use of BIGVIP System for authentication and access restriction of USERs enhances substantially the level of access control. Remote commands or programs or any objects seeking to access or modify core programs in a computer are denied access easily as screening and controlling is done to the level of individual objects, using ICTs authentication and Authenticated Dialogue Initiation. This provides more effective protection from malicious attacks and other harmful effects.

Alternate method of authentication avoiding repeated use of Biometrics: Biometric authentication is expensive. It also requires special hardware and software. At this stage it is unknown whether criminals could steal biometric identifiers also. Instead, NRBIGVIPs are useable, with any chosen level of PSI and chance of breach lower than what is achieved by Biometrics. Font/distinguishing property variations/Transformations are used to enhance security.

Use as an Independent Symmetric Encryption Key System: The System is capable of being used as an Independent Symmetric encryption Key System as such without any additional changes to the system. Only the inverse keys which are random numbers are exchanged which is decipherable only by USER/SERVICE PROVIDER in possession of VCS. Even the inverse keys are useable as encryption keys when unexposed as detailed in preceding paragraphs.

Internet Contract Transactions/Network Transactions (ICT): In the methods, a few common procedures are used. Of these, securing transactions and object exchanged in transactions, access restriction and ensuring continuity of link, and generating multiple Passwords from one Password have already been explained. The other common procedures are explained here to avoid repetition.

Chance to correct: All Calls, Passwords are verified for correctness and preagreed number of chances are allowed to rectify. Only on failure to rectify within the given chances, SERVICE PROVIDER/USER/USER agent software exit. Lapse of specified time or inability to open or decrypt folders indicate inability to correct and the parties exit. Exiting transactions are done duly advising the other party, when feasible.

Checking objects exchanged: It is an optional step to check objects exchanged before accepting or saving the files in their respective systems. The checks are for compliance of regulations, contract conditions, and freedom from undesirable programs like virus.

The methods are explained and will be readily understood by the following detailed description in conjunction with the accompanying drawings, wherein like reference numerals designate like structural elements. Only the main steps and important details are shown in drawings. More details are added in the disclosure. Ancillary steps, modifications to the steps and further detailing may be done suiting the SERVICE PROVIDER/USER/type of transaction.

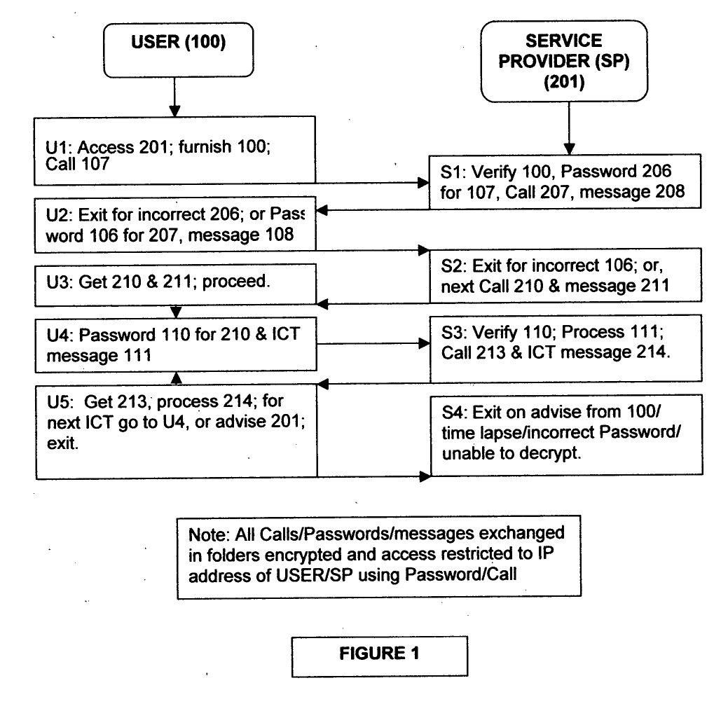

Method of authenticating and securing of every individual Internet Contract/Network transactions of USER with one Password furnished by a USER for each transaction: FIG. 1 is the flow chart of this method. In this, a USER (100) having an USER account with SERVICE PROVIDER (SP), having website (201) doing transactions is illustrated.

In step (U1), USER (100) accesses SP's website (201) by opening the website window; records IP address of SP (202), furnishes USER Name, 100 to SP, refers to authentication device (103) and issues a Call (107) within 103, to SP. This Call is termed as initial Call of the session. This Call is made in open network, is considered as exposed, and is unusable as encryption key.

In step (S1), SP checks 100, if 100 is unregistered, SP refers back. If 100 is registered, SP records IP address of USER (102); locates authentication device (203) pertaining to 100; checks whether the Call is within 203, if the Call is beyond 203, refers back; otherwise, SP creates a folder (205) containing Password (206) for 107, Call (207) termed as ‘SERVICE PROVIDER's first Call’ and any message to USER (208), the SP wants to communicate; encrypts 205 using 206, access restricts 205 to 102 using 206 as Password and sends to USER.

In step (U2), USER opens and decrypts 205 using preagreed cryptographic method and 206, which is obtained from 103; checks 206; exits if 206 is incorrect; otherwise creates a folder (105) containing Password (106) for 207 and any message to SP (108); encrypts 105 using 207, access restricts 105 to 202 using 207 as Password and sends to SP.

In step (S2), SP opens and decrypts 105, verifies 106; exits if USER authentication fails within allowed chances; if passes, creates a folder (209), containing next Call (210), authentication message to USER (211) encrypts 209 using 106, access restricts 209 to 102 using 106 as Password and sends to USER.

In step (U3), USER opens and decrypts 209; gets 210 & 211; proceeds with next step.

In step (U4), USER creates a folder (109) containing Password (110) for 210 & ICT message (111) encrypts 109 using 210 & access restricts 109 to 202 using 210 as Password and sends 109 to SP

In step (S3) SP opens and decrypts 109, verifies 110; checks 111 contents for acceptability; creates a folder (212) containing, next Call (213) & SP's ICT message (214) encrypts 212 using 110; access restricts 212 to 102 using 110 as Password and sends 212 to USER

In step, (U5) USER opens and decrypts 212, checks 214 contents for acceptability. If required to continue, proceeds to step U4, else advise SP and exits.

In step (S4) SP exits on advise from USER/lapse of specified time/incorrect Passwords/unable to decrypt.

The steps U4, S3, U5 are repeated for every transaction, with subsequent folders, Passwords, Calls and ICT messages.

The method uses one Password per transaction furnished by a USER. The method is independent of external securing system to secure transactions. Object exchanges are secured by system generated Call/Password. Two way authentication and access restriction of objects/messages exchanged ensures continuity of link between SERVICE PROVIDER and USER from beginning till end of session. USER and SERVICE PROVIDER use software programs designed to implement the method.

Example of a stock market transaction requiring individual authentication of each transaction is given below:

USER1 is a client and SP1 is a stockbroker. VCS 4 is the preagreed VCS. The initial dialogue prior to commencement of transactions is

SP1: Please furnish USER name

USER1: USER1

SP1, verifies USER1, if available, records IP address of USER1

USER1: 24, 53 (Call in open network)

SP1, checks whether the Call is correct. If correct, creates a folder containing Password: IAGNTN, Call: 43, 36 & message to USER1. Encrypts and access restricts the folder using “IAGNTN” and sends to USER1.

USER1 receives the folder from SP1, opens and decrypts the folder using ‘IAGNTN’, verifies Password is “IAGNTN” and gets the Call of SP1.

USER1 creates a folder containing Password to SP1's Call: RNNSWH, message, encrypts and access restricts the folder using “4336” and sends to SP1

SP1 opens and decrypts the folder from USER1, using “4336” checks the Password furnished by USER1, finding it correct, issues a welcome message, next Call 2, 67, encrypts and access restricts the folder using “RNNSWH” and sends to USER1.

When USER1 has created first order say sale1, creates a folder containing sale1 and Password: DWPP, encrypts and access restricts the folder using “267” and sends to SP1.

SP1 receives, opens and decrypts using ‘267’, verifies the Password and sale1 for compliance of rules and then dispatches it to stock exchange. SP1 creates a folder containing an acknowledgement message, next Call: 56, 22, encrypts and access restricts the folder using “DWPP” and sends to USER1.

USER1 receives, opens and decrypts using “DWPP” verifies the acknowledgement message, notes the next Call, and proceeds with next order/transaction if required. If not required, advises SP1 and exits.

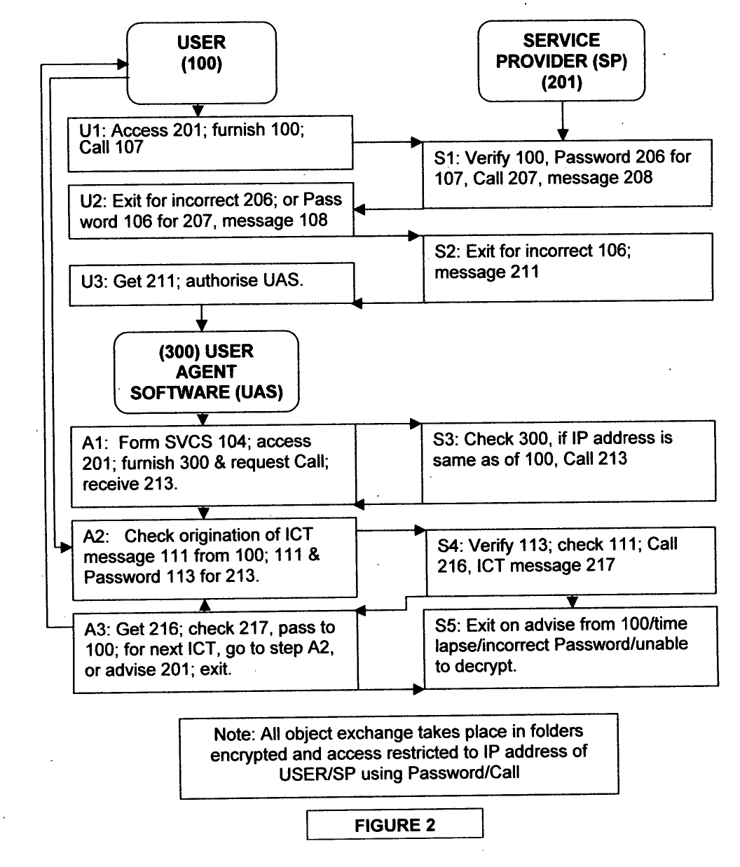

Method of authenticating and securing of every individual Internet Contract/Network transaction generating many Passwords from single Password furnished by USER: FIG. 2 is the flow chart of this method. In this, a USER (100) having an USER account with SERVICE PROVIDER (SP) having website (201), doing transactions, using USER Agent software (UAS) (300) is illustrated.

The steps U1, S1 and U2 are the same as in the method of authentication and securing of every ICT/Network Transactions with one Password furnished by a USER for each transaction. The step S2 is also the same except that the Call 210 is not sent to USER. These steps are not repeated here.

In step (U3) USER opens and decrypts 209; if authentication is successful, USER authorizes USER Agent software (UAS) to act further.

In step (A1) UAS collects 207 & 106, forms authentication device of the session (104) with 106 as Character Units & 207 as Serial Number of Character Units; (It is a convenient option; UAS could assign different Serial Number of Character Units and communicate it to SP using 106 to encrypt and access restrict); accesses 201; records 202; furnishes USER Name 300 & requests for Call. After SP responds receives, opens and decrypts 212, gets 213.

In step (S3) SP checks IP address of 300, if it is same as 102, creates a folder (212) containing Call (213) within 104, encrypts 212 using 106, access restricts 212 to 102 using 106 as Password and sends to UAS.

In step (A2) UAS receives ICT message (111) from USER; checks for origination of message from within 100 such as continuity of connection of 100 with SP, integrity of command to do the ICT, through checking keyboard and other input entries; creates a folder (112) containing, 111, Password (113) for 213, encrypts 112 using 213 & access restricts 112 to 202 using 213 as Password and sends 108 to SP In step (S4) SP opens and decrypts 112, verifies 113; checks 111 contents for acceptability; creates a folder (215) containing next Call (216), SP's ICT message (217) & encrypts 215 using 113; access restricts 215 to 102 using 113 as Password and sends 215 to UAS.

In step, (A3) UAS opens and decrypts 215, gets 216; checks 217 contents for acceptability and passes it to USER. If required to continue, proceeds to step A2 else advise SP and exits.

The steps A2, S4, A3 are repeated for every transaction, with subsequent folders, Passwords, Calls and ICT messages.

In step (S5) SP exits on advise from USER/lapse of time/incorrect Passwords/unable to decrypt.

The interaction between USER agent software and SERVICE PROVIDER takes place without efforts from USER. Only when authentication fails, it is brought to the notice of USER for USER to decide corrective action. Since SVCS/SVCS L2 is formed out of the USER's VCS/SVCS, it is also possible to do authentication directly by USER, if USER has noted down the initial Call of random numbers or Pass word. When necessary, USER, at any time, interrupts the USER Agent Software. ICTs created by other than authorized USER could not have access to SVCS/SVCS L2 applicable for that session. Any other person/object could not do ICT from any other computer in the name of USER1, because of access restriction to IP address, which differs. Even if it is attempted to originate ICT through the USER's computer, by remote commands, the keyboard entries and USER's commands differ and USER agent software rejects it. Thus, only authenticated ICT is sent to SERVICE PROVIDER and vice versa and every ICT is authenticated with a Password of the USER. It also ensures that the file or data packet containing ICTs exchanged between USER and SERVICE PROVIDER are access restricted between SERVICE PROVIDER and USER using Password or Call. USER is authenticated once and his actions are authenticated using the same Password with no further inputs from USER, who has option to do authentication directly or at any time interrupt USER Agent software. An exact link between USER and actions of USER is established, pinpointing, which USER did which ICT from which computer at what time using which Password, which is of definite use to solve ICT related claims. All actions of a USER are traceable from the moment a USER enters Internet through an Internet Service Provider, if all his transactions are treated as ICTs and effected in the manner laid down here. This is of immense use, in a time, when computers are illegally taken over and abused without knowledge of owners.

The method is characterised by using a USER Agent Software, to generate many variable Passwords from one initial Password furnished by USER, at the beginning of the session; authenticating and securing transactions using Call and Password, as two different computationally non intensive encryption keys linked to USER's identity to each one of the Internet/network transactions between USER and SERVICE PROVIDER; two way authentication and access restriction of objects/messages exchanged using two different Passwords/encryption keys for each transaction; ensuring continuity of link between SERVICE PROVIDER and USER from beginning till end of session; providing proof for every Internet Contract/Network Transaction of USERs; providing means of tracing all actions of USERs from access to exit, to solve Internet Contract/Network Transaction related claims. The method is independent of external securing system to secure transactions. USER and SERVICE PROVIDER use software programs designed to implement the method.

Example: Example of individual email authentication using the method of authenticating and securing of every individual Internet Contract/Network transaction generating many Passwords from single Password furnished by USER is given below:

USER1 is the USER, SP1 is the email server, and UAS is the email software, which functions as USER1's agent. VCS1 is the pre agreed VCS. USER1 has opened the website of SP1, indicating his desire to do email transaction and approached SP1.

| | |
|---|---|
| SP1: | Please enter your USER name |
| USER1: | USER1 |
| | SP1, verifies USER1, if available, records |
| | IP address of USER1 |
| USER1: | 73, 41, 100, 9 (Call in open network) |
| | SP1, checks whether the Call is correct. If correct, |
| | creates a folder containing Password: llmzdjGd, |
| Call: | 56, 2, 33, 87 and message to USER1. Encrypts and access |
| | retricts using “llmzdjGd” and sends to USER1. |

USER1 receives the folder from SP1, opens the folder by furnishing Password “IlmzdjGd”, decrypts using “IlmzdjGd” and gets the Call of SP1.

USER1 creates a folder containing Password to SP1's Call: 2j1D96OG and message, encrypts and access restricts the folder using “5623387” and sends to SP1

SP1 opens and decrypts the folder from USER1, using “5623387” checks Password furnished by USER1, finding it correct, welcomes USER1 (Welcome implies that USER is authenticated).

USER1 authorizes UAS, passing on the Call: 56, 2, 33, 87 and Password 2j1D96OG

UAS forms SVCS as below. Accesses SP1, furnishes USER Name, and seeks a Call.

| | | | | |
|---|---|---|---|---|
| SNCU | 56 | 2 | 33 | 87 |
| CU | 2j | 1D | 96 | OG |

SP1 checks IP address of UAS and if it is same as that of USER1, creates a folder containing a Call 56, 87, 33, encrypts and access restricts using 2j1D96OG and sends to UAS.

UAS, receives opens and decrypts using “2j1D96OG”, gets the Call and awaits ICT from USER1.

When USER1 has created first email say email1, it is passed on to UAS. UAS checks whether USER1, is logged in to the account, the commands match the email1, creates a folder containing email1, and Password: 2jOG96, encrypts and access restricts the folder using “568733” and sends to SP1.

SP1 receives, opens and decrypts using “568733”, verifies Password and email1 for compliance of rules and then dispatches it to the email address concerned. SP1 creates a folder containing an acknowledgement message and next Call: 56, 87 encrypts and access restricts the folder using “2jOG96” and sends to UAS.

UAS, receives, opens and decrypts using “2jOG96”, and verifies the message contents for acceptability and passes on to USER. Retains the Call. Subsequent emails could have Calls and Passwords as below:

| | |
|---|---|
| Email2, Call: 56, 87 | Password: 2jOG |
| Email3, Call: 87, 56, 2, 33 | Password: OG2j1D96 |
| Email4, Call: 56, 33, 2 | Password: 2j961D, etc. |

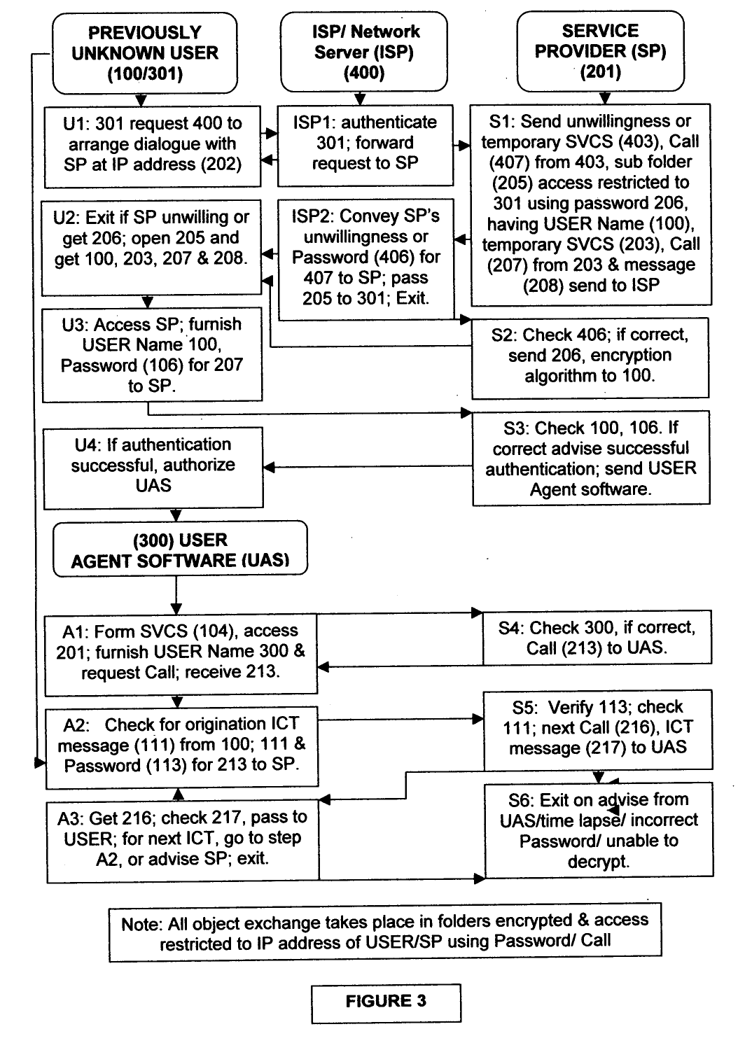

Method of authentication and securing of every individual Internet/Network transaction of a previously unknown USER generating different Passwords from one Password: FIG. 3 is the flow chart of this method. In this, a previously unknown USER (100/301) having an USER account with Internet SERVICE PROVIDER/Network Server (ISP), establishing authenticity to SERVICE PROVIDER having website (201) through the ISP and doing transactions, using USER Agent software is illustrated.

In step (U1), USER with IP address 102 and USER Name with ISP as 301, requests ISP (400) to arrange dialogue with SP, furnishing IP address of SP (202)

In step (ISP1), the ISP authenticates 301 with a Password (306) between USER & ISP; forwards USER's request to SP (201) with USER details

In step (S1), SP considers the request. If unwilling to transact with 301, sends unwillingness to ISP. If willing to transact, creates a folder (405) containing temporary SVCS (403) meant for ISP, a Call (407) from 403, a sub folder (205) containing USER Name (100), temporary SVCS meant for the previously unknown USER (203), a Call (207) from 203 & message (208), encrypts 205 with a Password to be sent later (206) & access restricts 205 to 102 using 206 as Password and sends 405 to ISP

In step (ISP2), the ISP conveys SP's unwillingness to USER if so received. If folder is received, opens folder 405, furnishes Password (406) for 407 to SP & passes on 205 to USER; ISP exits, after sending the folder to 301.

In step (S2), SP checks 406 received from ISP; if it is correct, then it sends 206 direct to previously unknown USER along with encryption algorithm.

In step (U2) previously unknown USER exits if SP unwilling to transact or gets 206 & encryption algorithm; opens 205 and gets 100, 203, 207 & 208.

In step (U3) previously unknown USER accesses SP's website (201); records IP address of SP (202), furnishes USER Name 100, creates a folder (105) containing, Password (106) for 207 to SP; encrypts 105 using 207, access restricts 105 to 202 using 207 as Password and sends to SP.

In step (S3) SP checks 100, records IP address of previously unknown USER (102); locates authentication device (203) opens and decrypts 105, verifies 106; If found correct, advises previously unknown USER's successful authentication; from this stage previously unknown USER, becomes an authenticated but temporary USER to SP; SP sends USER Agent software on request. SP exits if USER authentication fails, within 3 chances.

In step (U4) 100, authorizes UAS to act further, if authentication successful.

The steps that follow (A1), (S4), (A2), (S5), (A3) and (S6) are similar to steps (A1), (S3), (A2), (S4), (A3) and (S5) of the method of authenticating and securing of every individual Internet Contract/Network transaction generating many Passwords from single Password furnished by the USER. Other than the steps of initial authentication of previously unknown USER, this method has similar characteristic features of the previous method and hence not repeated here.

Example of a transaction of previously unknown USER participating in an auction is given below:

PUUSER wants to participate in the auction conducted by SP1. PUUSER is not registered with SP1.

PUUSER has account with ISP1.

PUUSER requests ISP1 to arrange a dialogue with SP1. ISP1 authenticates PUUSER with a Password. Passes on the request to SP1.

SP1 has MVCS1 as the authentication device. SP1 sends an SVCSr with SNCUs from 1 to 8 and Call 7, 4, 1 meant for ISP1 and SVCSn having SNCUs from 161 to 169 for PUUSER and Call 167, 169, 164, 166 meant for PUUSER, access restricts folder containing SVCSn, Call and Message to PUUSER's IP address, with a Password “PN3CRA” and sends to ISP1.

| | | | | | | | | | | | | | | | | |
|---|---|---|---|---|---|---|---|---|---|---|---|---|---|---|---|---|
| 1 | 2 | 3 | 4 | 5 | 6 | 7 | 8 | 161 | 162 | 163 | 164 | 165 | 166 | 167 | 168 | 169 |
| C | FP | XK | CT | 8O | RW | P4 | 4T | MI | DO | P4 | S1 | 7K | DZ | DD | 81 | HN |

SVCSr SVCSn

ISP1 furnishes Password: P4CT6C to SP1 and passes on the folder containing SVCS to PUUSER.

SP1 after verifying Password from ISP1, sends PUUSER, the Password “PN3CRA” to open the folder.

PUUSER's opens the folder, using “PN3CRA”, gets SVCSn, Call. Furnishes Password: DDHNS1DZ.

SP1 verifies and accepts to transact with PUUSER.

PUUSER gets UAS, authorizes UAS.

UAS forms SVCSL2 as below and seeks a Call.

| | | | |
|---|---|---|---|
| 167 | 169 | 164 | 166 |
| DD | HN | S1 | DZ |

SP1 issues Call: 166, 164, 167, encrypts using “DDHNS1DZ”.

UAS opens and decrypts the folder from SP1 using “DDHNS1 DZ” and gets the Call.

PUUSER participates in auction, witnesses bids in progress, makes the first bid say bid1, and passes it to UAS. UAS verifies the origination of message and creates folder with bid1, Password: DZS181, encrypted and access restricted using “166164167” sends it to SP1.

SP1 receives, opens and decrypts, checks Password and if correct accepts bid1. Sends acknowledgement, next Call in folder encrypted and access restricted with “DZS181” and sends to UAS.

UAS receives, opens and decrypts, checks and if everything is correct sends it to PUUSER, retains the Call. Awaits further bids from PUUSER.

The succeeding bids could have the following Calls and Passwords

| | |
|---|---|
| Bid2, Call: 164, 169 | Password: S1HN |
| Bid3, Call: 166, 169, 167 | Password: DZHNDD, etc. |

Authenticated Dialogue Initiation: Authenticated Dialogue Initiation between a USER and another party, in Internet, who is known or unknown to USER, is another use of BIGVIP System as a Call initiation method. In this case, a VCS with large number of CUs is defined for Authenticated Dialogue Initiation purpose and made public or available in a public server. Only BIGVIPs are used. When a USER wants to initiate a dialogue with any party, the USER calls for a Password from the VCS defined for Authenticated Dialogue Initiation purpose, from the party sought by USER, when sending the IP Address of the party. The party called by USER, furnishes Password, as VCS is public. USER checks IP Address of the party along with Password and if both are correct admits the party. Therefore, using this method, parties called for, are granted preferred access, parties uncalled for, are denied access or granted non-preferred access at USER's choice. Non preferred access implies that USER restricts the access to a boundary set by him. This method is simple and effective way of controlling initial access, similar to admitting guests for a function, with invitations. This method is computationally non-intensive.

Example: MVCS1 is the VCS published for Authenticated Dialogue Initiation purpose. USERX wants to initiate a Call to SPX, with domain name www.yespee_ex.com. USERX in the web browser, keys in the address: www.yespee_ex.com. In space provided for confirmation of the domain called, USERX indicates Call: 31, 298, 174. SPX on receipt of the Call, if willing to have dialogue with USERX, gets Password corresponding to the Call: KYUPLN and connects back to USERX. USERX verifies the confirmation Password “KYUPLN” and opens the website. USERX optionally blocks all the web sites if the confirmation Password is incorrect or not furnished.

Automatic Classification of USERs upon access: A user requiring to access a controlled sub domain has to access the main domain; furnish further details to queries of service provider for identifying user as belonging to the group eligible to access specific sub domain; then service provider evaluates the response to the queries and determines the users eligibility to access specific sub domain; then service provider allows or disallows user. Using MVCS/SVCS arrangement in BIGVIP system with Identification of SVCS called for as part of Password, checking Password alone identify Password subgroups and therefore, on access classification of USERs without obtaining further input data from USER and referring to previously stored information, is done. This facilitates decision on admissibility of a USER to specific sub domains within a domain. Post access routing is decided and effected without further independent checks. In other words, on access classification and routing is done in one step. This reduces one or more stages of communication and therefore confers substantial advantage of reducing communication costs (Internet as well as other communications)

Example: A software company is having, customers who have purchased various software. Software updates are made available on Internet only for USERs who have bought the particular software. In existing Password systems, the customer has to go to Home/main page of the company, enter user name and Password, go to specific page/link providing update, furnish details of purchase or registration number of software, seek update and then get update. In this process one or more stages of communication i.e. User going to specific page/link providing update, furnishing details of purchase or registration number of software, seeking update and the company verifying data and taking decision to allow or disallow is involved. Using BIGVIP system, this task is simplified. All buyers of particular software are assigned SVCS with partly common SVCS identification (say last 2 characters of Password is AA). USER has to go to Home/main page of the company, enter USER name and Password and seek specific update (from main page itself). The company only has to verify USER name, Password and whether last two characters of Password are AA, and directly allow specific update.

### INDUSTRIAL APPLICABILITY

BIGVIP System with BIGVIPs and NRBIGVIPs are useable in place of static Passwords with substantially enhanced security than static Passwords. With low cost, BIGVIPs and NRBIGVIPs are useable in place of Dynamic or One-time Password systems with advantages of convenience (without cumbersome procedures), desired level of (equivalent or higher) security. They are useable as substitute for Biometric authentication, avoiding risk of theft of Biometric features. They are useable in authentication and securing of ICTs, Local/Wide area Network transactions and Authenticated Dialogue initiation for which static Passwords or Dynamic Passwords or One-time Passwords or Biometric authentication are unusable. They are useful as Independent Symmetric Encryption Key System. In short they are useable for any one or any thing, requiring authentication and securing, with desired level of security, higher than what is provided by present Password systems and Biometric Authentication. Using MVCS/SVCS in BIGVIP system, on access classification of USER and directly routing to the required link is done, reducing one or more stages of Communication and the communication costs.

TABLE I
For VCS 1 to VCS 5, Serial Number of Character Units should be reckoned as column number x 10 +
row number. For VCS 6, it is = row number x 10 + column number. Column numbers are indicated in
top row and row numbers are indicated in the leftmost column.
VCS 1

| | 0 | 1 | 2 | 3 | 4 | 5 | 6 | 7 | 8 | 9 |
|---|---|---|---|---|---|---|---|---|---|---|
| 1 | pF | lO | Bu | lm | mZ | cl | KQ | Fm | $C | ae |
| 2 | 1D | f9 | Vr | sN | OU | xP | JL | 2u | aO | AC |
| 3 | $h | yy | lZ | 96 | rA | Sr | qG | ll | 0U | LC |
| 4 | za | 2r | Em | Ov | NV | r@ | eF | $q | lt | 1x |
| 5 | Xn | DP | Kn | Hy | pn | cE | OK | OS | cl | 1p |
| 6 | Jf | 0N | 1z | 3P | kG | 2j | QO | 7s | pK | b1 |
| 7 | bw | 6Y | lm | vW | GW | qX | wW | vn | OG | V9 |
| 8 | CO | ce | tM | ok | a1 | DX | KM | zL | 60 | Tm |
| 9 | Gd | zS | wl | 1u | $E | La | zF | Ul | gl | Pl |
| 10 | y5 | ze | aY | CU | b1 | tM | @x | Qa | l1 | dj |

VCS 2

| | 0 | 1 | 2 | 3 | 4 | 5 | 6 | 7 |
|---|---|---|---|---|---|---|---|---|
| 1 | 69 | 868 | 15 | 386 | 536 | 195 | 465 | 506 |
| 2 | 291 | 61 | 129 | 818 | 104 | 799 | 822 | 511 |
| 3 | 559 | 219 | 374 | 982 | 638 | 384 | 135 | 308 |
| 4 | 62 | 429 | 224 | 269 | 526 | 340 | 878 | 527 |
| 5 | 430 | 823 | 991 | 988 | 916 | 711 | 105 | 973 |
| 6 | 974 | 317 | 498 | 472 | 228 | 542 | 987 | 669 |
| 7 | 383 | 504 | 900 | 155 | 420 | 705 | 365 | 910 |
| 8 | 967 | 188 | 552 | 463 | 992 | 893 | 488 | 153 |
| 9 | 811 | 81 | 652 | 329 | 63 | 821 | 323 | 666 |
| 10 | 688 | 7 | 617 | 386 | 313 | 5 | 172 | 924 |

VCS 3

| | 0 | 1 | 2 | 3 | 4 | 5 | 6 | 7 | 8 | 9 | 10 | 11 | 12 | 13 | 14 |
|---|---|---|---|---|---|---|---|---|---|---|---|---|---|---|---|
| 1 | 2 | B | S | n | h | A | 7 | c | Q | 1 | S | y | q | G | S |
| 2 | D | 4 | j | u | U | 1 | 4 | 8 | b | c | H | 1 | d | A | V |
| 3 | Y | w | l | L | n | x | C | B | 6 | E | @ | P | z | m | A |
| 4 | F | m | Z | q | o | 9 | 5 | d | h | 3 | E | J | 8 | B | F |
| 5 | o | f | v | g | x | u | f | 0 | E | m | E | x | 9 | z | D |
| 6 | 5 | c | l | y | 6 | 4 | $ | n | B | f | G | O | 0 | U | A |
| 7 | B | A | R | q | 4 | h | P | h | P | k | K | e | n | 9 | L |
| 8 | l | l | f | g | 5 | G | R | P | b | G | L | A | s | R | O |
| 9 | E | 9 | b | 9 | 3 | C | m | 4 | 9 | d | T | P | m | V | A |
| 10 | 6 | 5 | T | j | o | T | 6 | Q | 2 | 6 | X | L | X | H | Q |

VCS 4

| | 0 | 1 | 2 | 3 | 4 | 5 | 6 | 7 |
|---|---|---|---|---|---|---|---|---|
| 1 | DPF | TBZ | KXK | BNR | QBX | EFQ | HGS | IGO |
| 2 | D | AKK | HMH | YLG | QUZ | OHS | GHT | JMS |
| 3 | GNO | XGD | ET | PBA | RNN | NTN | CXK | HFL |
| 4 | GFX | FKA | IAG | CIE | QGU | LJB | BJD | PHC |
| 5 | YSI | QQ | OBZ | XRH | UJM | AIS | SVG | TUQ |
| 6 | NKA | AXP | DOQ | SWH | A | DLL | RHT | BEQ |
| 7 | YDY | NMU | PFJ | KSU | TDX | STD | WPP | JY |
| 8 | JJY | ML | GVQ | HYP | PFN | AMB | BVC | NVN |
| 9 | OSW | FJD | MKL | LMQ | TBO | LDF | VCL | BGJ |
| 10 | VHU | XJT | JUO | GEO | XET | EQ | CQL | RXC |

VCS Details

| | | | No. of |
|---|---|---|---|
| VCS No. | Basic Characters used | No. of Basic Characters per Character Unit | Character Units |
| 1 | 64; A-Z, a-z, 0-9, @, $ | 2 | 100 |
| 2 | 10; 0-9 | 3 | 80 |
| 3 | 64; A-Z, a-z, 0-9, @, $ | 1 | 150 |
| 4 | 26; A-Z | 3 | 80 |

TABLE II

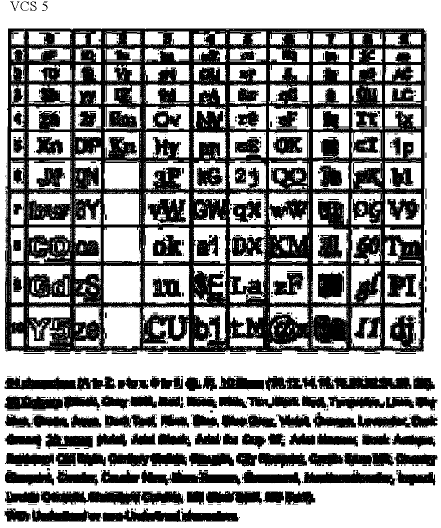

TABLE III

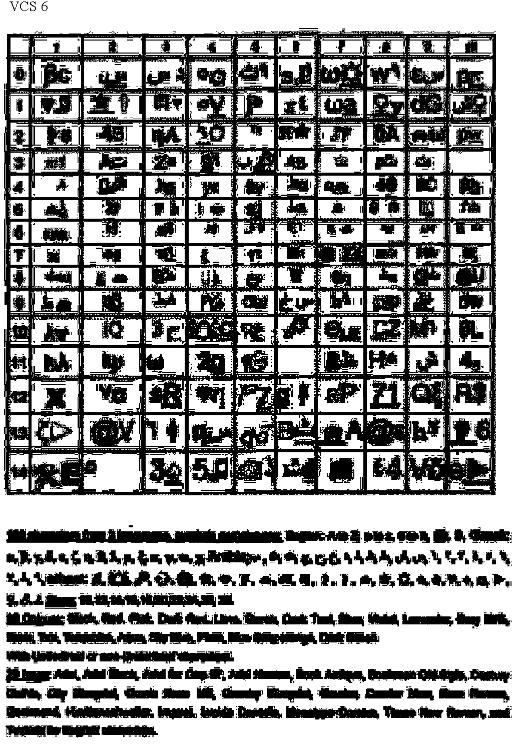

TABLE IV-A

| | | | | Number | Total | | | Number of possible | Number of |
|---|---|---|---|---|---|---|---|---|---|
| | | | | of | Number of | Number | Number | Passwords using all | Unique Passwords |
| | | | Number | Basic | Character | of | of | Character Units | using all |
| | SI. | | of | Characters | Units in | Character | possible | in Variable | Basic |
| | No. | Basic | Basic | forming a | Variable | Units | Character | Character | Characters |
| SI. | of | Character | Characters | Character | Character | in | Units | Set | 10 |
| No. | VCS | used | used | Unit | Set | Password | 8 | 9 | C4ˆ(C5* |
| 1 | 2 | 3 | 4 | 5 | 6 | 7 | C4ˆC5 | C6ˆC7 | C7) |
| 1 | 1 | A-Z, a-z, | 64 | 2 | 100 | 2 | 4096 | 1.00E+04 | 1.68E+07 |
| 2 | | 0-9, 169 ,$ | 64 | 2 | 100 | 3 | 4096 | 1.00E+06 | 6.87E+10 |
| 3 | | | 64 | 2 | 100 | 4 | 4096 | 1.00E+08 | 2.81E+14 |
| 4 | 2 | 0-9 | 10 | 3 | 80 | 3 | 1000 | 5.12E+05 | 1.00E+09 |
| 5 | | | 10 | 3 | 80 | 4 | 1000 | 4.10E+07 | 1.00E+12 |
| 6 | 3 | A-Z, a-z, | 64 | 1 | 150 | 4 | 64 | 5.06E+08 | 1.68E+07 |
| 7 | | 0-9, 169 ,$ | 64 | 1 | 150 | 5 | 64 | 7.59E+10 | 1.07E+09 |
| 8 | | | 64 | 1 | 150 | 6 | 64 | 1.14E+13 | 6.87E+10 |
| 9 | | | 64 | 1 | 150 | 7 | 64 | 1.71E+15 | 4.40E+12 |
| 10 | | | 64 | 1 | 150 | 8 | 64 | 2.56E+17 | 2.81E+14 |

| | Chance | | Number | Number of | Chance of | | |
|---|---|---|---|---|---|---|---|
| | of 3 | Password | of | possible | 3 Random | Password | |
| | Random Trials | Safety | Non | Passwords | Trials on Non | Safety | Number |
| | on all | Index | Repeating | with | Repeating | Index | of |
| | Characters | (BIGVIP) | Character | Non Repeating | Characters 1 in | (NRBIGVIP) | possible |
| SI. | Units 1 in | 12 | Units in | Characters | 15 | 16 | VCSs |
| No. | 11 | log(C11)/) | Password | 14 | C4ˆ(C5* | log(C15)/ | 17 |
| 1 | C10/3 | log(2) | 13 | C6/C13 | C13)/3 | log(2) | ^{(C8)}P_{(C6)} |
| 1 | 5.59E+06 | 22 | 2 | 50 | 5.59E+06 | 22 | VLN |
| 2 | 2.29E+10 | 34 | 2 | 50 | 5.59E+06 | 22 | VLN |
| 3 | 9.38E+13 | 46 | 3 | 33 | 2.29E+10 | 34 | VLN |
| 4 | 3.33E+08 | 28 | 2 | 40 | 3.33E+05 | 18 | 4 E+238 |
| 5 | 3.33E+11 | 38 | 3 | 26 | 3.33E+08 | 28 | 4 E+238 |
| 6 | 5.59E+06 | 22 | 3 | 50 | 8.74E+04 | 16 | VLN |
| 7 | 3.58E+08 | 28 | 4 | 37 | 5.59E+06 | 22 | VLN |
| 8 | 2.29E+10 | 34 | 5 | 30 | 3.58E+08 | 28 | VLN |
| 9 | 1.47E+12 | 40 | 6 | 25 | 2.29E+10 | 34 | VLN |
| 10 | 9.38E+13 | 46 | 7 | 21 | 1.47E+12 | 40 | VLN |

TABLE IV-B

| | | | | Number | Total | | | Number of possible | Number of |
|---|---|---|---|---|---|---|---|---|---|
| | | | | of | Number of | Number | Number | Passwords using all | Unique Passwords |
| | | | Number | Basic | Character | of | of | Character Units | using all |
| | SI. | | of | Characters | Units in | Character | possible | in Variable | Basic |
| | No. | Basic | Basic | forming a | Variable | Units | Character | Character | Characters |
| SI. | of | Character | Characters | Character | Character | in | Units | Set | 10 |
| No. | VCS | used | used | Unit | Set | Password | 8 | 9 | C4ˆ(C5* |
| 1 | 2 | 3 | 4 | 5 | 6 | 7 | C4ˆC5 | C6ˆC7 | C7) |
| 11 | 4 | A-Z | 26 | 3 | 80 | 2 | 17576 | 6.40E+03 | 3.09E+08 |
| 12 | | | 26 | 3 | 80 | 3 | 17576 | 5.12E+05 | 5.43E+12 |
| 13 | | | 26 | 3 | 80 | 4 | 17576 | 4.10E+07 | 9.54E+16 |
| 14 | 5 | As in | 512000 | 2 | 100 | 2 | 2.62E+11 | 1.00E+04 | 6.87E+22 |
| 15 | | Table II | 512000 | 2 | 100 | 3 | 2.62E+11 | 1.00E+06 | 1.80E+34 |
| 16 | | | 512000 | 2 | 100 | 4 | 2.62E+11 | 1.00E+08 | 4.72E+45 |
| 17 | | | 512000 | 2 | 100 | 5 | 2.62E+11 | 1.00E+10 | 1.24E+57 |
| 18 | | | 512000 | 2 | 100 | 6 | 2.62E+11 | 1.00E+12 | 3.25E+68 |
| 19 | 6 | As in | 536400 | 2 | 150 | 3 | 2.62E+11 | 3.38E+06 | 2.38E+34 |
| 20 | | Table III | 536400 | 2 | 150 | 4 | 2.62E+11 | 5.06E+08 | 6.85E+45 |

| | Chance | | Number | Number of | Chance of | | |
|---|---|---|---|---|---|---|---|
| | of 3 | Password | of | possible | 3 Random | Password | |
| | Random Trials | Safety | Non | Passwords | Trials on Non | Safety | Number |
| | on all | Index | Repeating | with | Repeating | Index | of |
| | Characters | (BIGVIP) | Character | Non Repeating | Characters 1 in | (NRBIGVIP) | possible |
| SI. | Units 1 in | 12 | Units in | Characters | 15 | 16 | VCSs |
| No. | 11 | log(C11)/) | Password | 14 | C4ˆ(C5* | log(C15)/ | 17 |
| 1 | C10/3 | log(2) | 13 | C6/C13 | C13)/3 | log(2) | ^{(C8)}P_{(C6)} |
| 11 | 1.03E+08 | 27 | 2 | 40 | 1.03E+08 | 27 | VLN |
| 12 | 1.81E+12 | 41 | 2 | 40 | 1.03E+08 | 27 | VLN |
| 13 | 3.18E+16 | 55 | 3 | 26 | 1.81E+12 | 41 | VLN |
| 14 | 2.29E+22 | 74 | 1 | 100 | 8.74E+10 | 36 | VLN |
| 15 | 6.00E+33 | 112 | 2 | 50 | 2.29E+22 | 74 | VLN |
| 16 | 1.57E+45 | 150 | 3 | 33 | 6.00E+33 | 112 | VLN |
| 17 | 4.13E+56 | 188 | 4 | 25 | 1.57E+45 | 150 | VLN |
| 18 | 1.08E+68 | 226 | 5 | 20 | 4.13E+56 | 188 | VLN |
| 19 | 7.94E+33 | 113 | 2 | 75 | 2.76E+22 | 75 | VLN |
| 20 | 2.28E+45 | 151 | 3 | 50 | 7.94E+33 | 113 | VLN |

TABLE V
MVCS 1

| | 1 | 2 | 3 | 4 | 5 | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|---|---|---|---|---|
| 0 | 6C | FP | XK | CT | 8O | RW | P4 | 4T | MV | 6J | JO | K0 | 64 | 3H | CG | 88 | EL | MU | VF | JM |
| 1 | H6 | DQ | P3 | 9E | CW | N9 | 5C | 3D | 5A | M8 | KY | SZ | TS | 7N | 8Y | JS | R3 | 5Q | I9 | 8T |
| 2 | L6 | EA | HZ | RU | TT | 2W | 5W | 55 | KR | 0P | 34 | 4F | LR | 83 | KY | YY | QW | LQ | JZ | Y2 |
| 3 | Q9 | U7 | 1X | 32 | TA | SH | J0 | QU | KS | PD | BI | RJ | JO | C4 | JA | JE | GQ | 1V | M2 | PD |
| 4 | CH | Q7 | TN | 61 | 43 | SN | 1Y | 3C | X0 | LE | MT | F5 | QF | PS | 1O | CX | LF | L7 | 21 | XJ |
| 5 | EJ | E8 | IY | 5X | EM | 1M | CC | GG | PD | P6 | 3P | S8 | YM | QM | 59 | 0M | XB | 5X | Z9 | SS |
| 6 | JT | N1 | 4W | FA | 1W | ED | YE | 8A | PY | QP | 2W | QM | T4 | IE | 4U | IC | 37 | 5D | 2U | KD |
| 7 | FQ | WV | ZE | E2 | 2O | J3 | RH | 2D | CY | 7M | NG | UX | BQ | B2 | BI | C6 | LC | EO | KQ | RR |
| 8 | MI | DO | P4 | S1 | 7K | DZ | DD | 81 | HN | CU | II | M8 | E1 | V9 | A1 | L8 | V1 | VB | 58 | 44 |
| 9 | J0 | 87 | GZ | TT | 68 | JK | 9Y | L3 | OC | O5 | 4C | 4M | PY | LN | 76 | 4R | EP | G1 | IK | OQ |
| 10 | TS | XM | 1J | EG | O8 | WL | EU | SL | FE | SV | MQ | FU | BE | BU | 1T | A6 | XP | RQ | AH | NW |
| 11 | T6 | A8 | FF | R5 | 4J | MD | BH | 6D | L9 | 5W | MP | GW | 73 | 3A | 94 | 6I | FI | G0 | AY | X6 |
| 12 | MB | HU | A3 | 86 | ET | JL | OV | PN | 3I | X2 | C8 | Q8 | 59 | WH | H2 | PJ | KZ | L6 | 9Y | LL |
| 13 | YC | XI | TY | 2H | L5 | NC | XO | EW | AZ | Z2 | OU | Y9 | G1 | L6 | 2Q | 3G | O6 | F6 | UL | 00 |
| 14 | XY | 5W | V5 | TO | HJ | N7 | ML | 7F | 7Y | WD | N5 | IJ | RA | 8M | XJ | JC | 8F | UP | 3C | 1A |

36 Basic Characters (A to Z and 0 to 9), 2 Basic Characters per Character Unit, 300 Character Units.
Serial Number of Character Units should be reckoned as row number x 20 + column number. Column numbers are indicated in the top row and row numbers are indicated in the leftmost column.

1. I claim a System for authenticating concurrently securing Internet transactions providing one Password cum symmetric encryption key for each lap of a transaction, two Password cum symmetric encryption keys for two laps of each transaction and a Plurality of Password cum symmetric encryption keys for a session, further enabling authenticated dialogue initiation and USER classification on access, including authentication devices printed on a physical medium such as paper, digital form and/or similar means, a memory device, a data processor loaded with software implementing the system for USER and SERVICE PROVIDER, connected by communication network or not, wherein, authenticating user using a single variable Password at the beginning of a session having a plurality of transactions, securing a session having a plurality of transactions using a single encryption key characterized in that (a) providing protocol for continuous mutual authentication of USER/Previously Unknown USER and SERVICE PROVIDER for every single transaction from beginning to end of session, employing one variable Password for each lap of a transaction, two variable Passwords per transaction of two consecutive laps, one lap from USER to SERVICE PROVIDER, the other lap from SERVICE PROVIDER to USER and a plurality of variable Passwords for a session having a plurality of transactions; (b) using the said plurality of variable Passwords and Calls for said plurality of variable Passwords as symmetric encryption keys; (c) securing every single object exchanged between USER/Previously Unknown USER and SERVICE PROVIDER employing one encryption key for each object, the said single object include all communications arising from one lap of a transaction between USER/Previously Unknown USER and SERVICE PROVIDER, such as files, message packets, Call, Password/encryption keys bundled in to single folder; (d) securing every single transaction between USER/Previously Unknown USER and SERVICE PROVIDER employing two encryption keys per transaction of two consecutive laps, one lap from USER to SERVICE PROVIDER, the other lap from SERVICE PROVIDER to USER; (e) the first of the said two encryption keys per transaction, furnished by USER/Previously Unknown USER as Password, the second of the said two encryption keys per transaction generated by concatenating the ‘Call’ excluding the first Call of session, available from the system; (f) employing a plurality of Passwords per session, half the number of the said plurality of Passwords provided by at least one method of (g) generating a plurality of Passwords from single initial Password furnished by USER/Previously Unknown USER in step (e), using a software termed as USER AGENT SOFTWARE and (h) direct keying in by USER/Previously Unknown USER for every transaction, (i) the second half the number of the said plurality of Passwords generated by concatenating the ‘Call’ available from the system; (j) initiating secure session of plurality of transactions making a Call termed as the first Call of session, in open network, the said first Call identifying the first encryption key to be used for securing the first object of the first transaction between USER and SERVICE PROVIDER, the said Call decipherable only between USER and SERVICE PROVIDER, whereby secure communication link is established only with the authorized, preventing unauthorized substitutions and clandestine diversions of the said secure communication; (k) continuously changing encryption keys integrated in to the system, dispensing with the effort for prior communication of encryption keys (l) the said continuously changing encryption keys decipherable only at the Internet Protocol address wherefrom the USER/Previously Unknown USER/SERVICE PROVIDER commenced transaction and upon furnishing valid Password for each object: (m) steps (j) to (l), ensuring continuous link between USER/Previously Unknown USER and SERVICE PROVIDER from the first to the last transaction preventing attacks such as intrusions, spoofing, substitutions, diversions and remote operations by unauthorized (n) USERs of the system include objects and Previously Unknown USERs; (o) the said system providing proof of transactions of USERs and Previously Unknown USERs as direct means of tracing source of objects received by USERs and SERVICE PROVIDERs in a computationally non intensive manner for identification of source of internet crimes and settlement of claims arising in internet; (p) the said system providing dialogue initiation, the means of identification of attempted access by parties including unknown parties as to whether the party attempting to access is invited or not and prevent from uninvited/undesired access by parties; (q) the said system dispensing with repeated furnishing of details at every access to the controlled sub domains of SERVICE PROVIDERs, reducing at least one step of communication; (r) the said system usable as independent symmetric encryption key system continuously changing encryption keys for each object exchanged; (s) the said system comprising (s1) a second system of authentication devices; (s2) font/distinguishing property modification of printed authentication devices; (s3) transformation of the authentication devices; (s4) authentication including using Call as Password; (s5) Bilaterally Generated Variable Instant Passwords and Non Repeating Bilaterally Generated Variable Instant Passwords; (s6) authentication and access restriction of USERs to protect Networks, computer systems, data, software, hardware, camera, mobile phone, and similar systems to the level of specified sector of data storage media; (s7) authentication and securing transactions with one Password furnished by USER for every transaction; (s8) USER agent software; (s9) generating multiple Passwords from single Password (s10) authentication and securing transactions by generating multiple Passwords from single Password of USER; (s11) authentication and securing transactions by generating multiple Passwords from single Password furnished from a temporary authentication device by a Previously Unknown USER; (s12) authenticated dialogue initiation and (s13) automatic classification of USERs on access.

2. The system claimed as claim 1, (a) USER is a person or a process or software or specified sector(s) of data storage media or a system or server or a Network or any thing that uses a Password for authentication; (b) a Previously Unknown USER is a USER having an USER account with a Internet SERVICE PROVIDER or Network server but is yet to establish an USER account with a SERVICE PROVIDER with whom such USER wants to transact and includes first time/temporary USERs/short duration USERs excused from having an USER account such as participants in auctions; (c) SERVICE PROVIDER is a person or a process or software or specified sector(s) of data storage media or a system or server or a Network or any thing who/which provides access to the USER upon furnishing of valid Password for authentication.

3. The system claimed as claim 1, (a) authentication device is any one of Variable Character Set system of authentication device pre agreed between USER and SERVICE PROVIDER; (b) temporary authentication device is an authentication device generated from Variable Character Set system of authentication device by SERVICE PROVIDER and sent to a Previously Unknown USER through Internet Service Provider/Network Server

4. The system claimed as claim 1, (a) Call is step of the authentication process of the system made by SERVICE PROVIDER to USER or vice versa, in terms of serial numbers of Character Units, requiring a Response to furnish Character Units of the authentication device, made of instantly generated random numbers, each of which is equal to or less than the total number of Character Units of authentication device; (b) Response is the answer furnished for a Call, in terms of Character Units of the authentication device, whose serial numbers of Character Units are the numbers called in the order of Call, typed as continuous string of Character Units; (c) Passwords generated using the system include Bilaterally Generated Variable Instant Passwords, Non Repeating Bilaterally Generated Variable Instant Passwords and random numbers of Call, concatenated, wherein all Calls except the session initiating Call are made within secure session; (d) two Passwords per transaction is using either Bilaterally Generated Variable Instant Password or Non Repeating Bilaterally Generated Variable Instant Password and the random numbers of Call, concatenated.

5. The system claimed as claim 1, (a) a transaction comprise of two consecutive laps, one lap from USER to SERVICE PROVIDER, the other lap from SERVICE PROVIDER to USER, each lap involving exchange of single object between USER and SERVICE PROVIDER, wherein objects are exchanged using one Password per object, wherein the said object is a folder containing communication, such as files, message packets, Calls, Passwords, the said folder is encrypted and access restricted between USER and SERVICE PROVIDER; (b) Internet Contract transaction is an Internet transaction between USER and SERVICE PROVIDER which has a monetary or other value wherein USER transacts using an USER name and authenticated by Passwords.

6. The system claimed as claim 1, continuous mutual authentication is verification of identity of USER and SERVICE PROVIDER mutually for every single object exchanged, using different Passwords/Calls linked to the identity of USER.

7. The system claimed as claim 1, providing proof for a transaction is to preserve the Call and Pass word of each transaction along with Internet Protocol address wherefrom USER and SERVICE PROVIDER transacted, date, time and USER details, including Internet Protocol address of Internet Service Provider/Network Server who forwarded the request of Previously Unknown USER, as means of tracing source of objects in a direct and computationally non intensive manner.

8. The system claimed as claim 1 independent symmetric encryption key system comprising: (a) USER/SERVICE PROVIDER making the first Call in a session, wherein the said first Call is made in open network before start of encrypted session and is the inverse key which identifies the encryption key to be used; (b) SERVICE PROVIDER/USER using the Password to the said first Call as the first encryption key to start a secure session; (c) SERVICE PROVIDER communicating further Calls within encrypted session (d) USER and SERVICE PROVIDER using a Password for a transaction and random numbers of Call, concatenated, for the said transaction as two encryption keys for each transaction (e) USER and SERVICE PROVIDER continuously changing encryption keys at the rate of one per object exchanged in each lap of every single transaction.

9. I claim a second system of authentication devices termed as Variable Character Set system of authentication devices used as means of generating variable and instant Passwords and authenticating USERs and SERVICE PROVIDERs in Bilaterally Generated Variable Instant Password System, the said authentication devices printed on a physical medium such as paper, digital form and/or similar means, stored in a memory device with data processor, comprising: (a) Variable Character Sets {VCS 1 to VCS 6}, (b) Master Variable Character Sets {MVCS 1}, (c) Sub Variable Character Sets and (d) Sub Variable Character Sets of Level 2 or below; wherein the functional combinations comprising: (e) both SERVICE PROVIDER and USER using Variable Character Set; (f) SERVICE PROVIDER using Master Variable Character Set with a Sub Variable Character Set expressed in brief form and USER using Sub Variable Character Set; (g) SERVICE PROVIDER using Master Variable Character Set with a Sub Variable Character Set of Level 2 or below expressed in brief form and USER using a Sub Variable Character Set of Level 2 or below, wherein at least one of the said combinations given herein as (e), (f) and (g) are used as the authentication device, wherein an authentication device of the said system further comprising: (h) an arrangement of a plurality of Character Units in which the Character Units are identified using unique Serial Number of Character Units; (i) the Character Unit consist of either one or a permutation of more than one Basic Character wherein the said random permutation includes repeating a Basic Character within same Character Unit; (j) the Basic Characters are selected from a plurality of characters including alphanumeric characters chosen from a plurality of languages/scripts/numbers/symbol systems including non familiar languages/scripts/numbers/symbol and graphical characters chosen from a plurality of representation of objects including diagrams, drawings, images, photos, pictures and sketches; (k) the characters are further differentiated by font/distinguishing properties; characterized in that (l) memorization is dispensed with; (m) the Character Units of the said arrangement comprise of completely random characters; (n) the total number of Character Units in the authentication device is unrestricted by human memorizable level removing the corresponding limit on Serial Number of Character Units imposable by memorization; (o) the Serial Number of Character Units identify corresponding Character Unit; no further relationship exists between Character Units and Serial Number of Character Units and no relation ship exists among the Character Units in the said arrangement; (p) the said arrangement is free from algorithms/pattern forming methods, requiring recalling and implementation of the said algorithms/pattern forming methods to produce Password; (q) the authentication devices produce Passwords of chosen level of safety; (r) the functional combinations given herein as (f) and (g), facilitating single authentication device providing required number of related sub authentication devices for assigning to a plurality of USERs/USER groups/uses, reducing data storage requirement of SERVICE PROVIDER, providing ease of identifying Character Units in programs in terms of Serial Number of Character Units of Master Variable Character Set; (s) facilitating classification of USERs and generation of several Passwords from single Password initially furnished by a USER linking with identity of USER.

10. The system claimed as claim 9, method of generating and using a Variable Character Set comprising the steps of (a) selecting the required number of Character Units; (b) arranging the Character Units in any one form of lists, tables, arrays and matrices, in which each of the Character Unit is distinctly identifiable and easily readable; (c) assigning unique Serial Number of Character Unit to identify each Character Unit in Variable Character Set; (d) specifying the method of identifying/calculating the Serial Number of Character Unit, facilitating USER to read the Character Units corresponding to the Serial Number of Character Units; (e) ensuring that the Character Units and the Serial Number of Character Units are unrelated and the Character Units of a Variable Character Set are unrelated to each other; (f) printing the said arrangement in a physical medium such as paper, digital form optionally in encrypted file form and/or similar means; (g) SERVICE PROVIDER and USER storing the arrangement securely in a memory device; (h) optionally, SERVICE PROVIDER validating USER generated Variable Character Set for compliance of the above steps (a) to (g); wherein (i) USER upon being a Previously Unknown USER to a SERVICE PROVIDER but known to another SERVICE PROVIDER passing the said Variable Character Set to the said Previously Unknown USER through the said known SERVICE PROVIDER and (j) USER upon being an Unknown USER, publishing the said Variable Character Set.

11. The system claimed as claim 9, method of generating and using a Master Variable Character Set comprising the steps of (a) generating a Variable Character Set and designating it as the Master Variable Character Set; (b) upon-generation of Sub Variable Character Sets by USERs, generating the Master Variable Character Set by combining the said USER generated Sub Variable Character Sets of all USERs of a SERVICE PROVIDER, as continuous and non-overlapping lists or tables or arrays or matrices; (c) storing and using the arrangement securely by SERVICE PROVIDER

12. The system claimed as Claim 9, method of generating and using Sub Variable Character Set comprising the steps of (a) selecting the total number of Character Units of the Sub Variable Character Set; (b) identifying Serial Number of Character Units of the Master Variable Character Set, the method of identifying the said Serial Number of Character Units adopting at least one of the following ways: (b1) specifying rules of selection such as criteria for filtering data, (b2) specifying discrete numbers, (b3) specifying continuous numbers and (b4) specifying random sequences; the Character units corresponding to the identified Serial Number of Character Units constituting the Sub Variable Character Set (c) selecting Character Units including a limited number of Character Units of other Sub Variable Character Sets, duly ensuring that no specific relationship exists, between Character Units of Sub Variable Character Sets of same origin (d) arranging Character Units selected as per steps (a) to (c) herein, to any one of the form of lists, tables, arrays and matrices, in which each of the Character Unit is distinctly identifiable and easily readable; (e) assigning unique Serial Number of Character Units, independent of Serial Number of Character Units of Master Variable Character Set to identify each Character Unit in the Sub Variable Character Set; (f) specifying the method of identifying/calculating the Serial Number of Character Unit, facilitating USER to read the Character Units corresponding to the Serial Number of Character Units; (g) ensuring Character Units and Serial Number of Character Units are unrelated and the Character Units of a Sub Variable Character Set are unrelated to each other; (h) assigning a Serial Number/identification number to each Sub Variable Character Set, (i) optionally USER generating Variable Character Set and using it as Sub Variable Character Set (j) SERVICE PROVIDER storing Sub Variable Character Sets in brief form as in step (b); (k) USERs storing Sub Variable Character Sets in complete form (l) wherein when using Sub Variable Character Sets, (m) the Password Calls are in Serial Number of Character Units of Sub Variable Character Sets and SERVICE PROVIDER compares with Character Units of Master Variable Character Set corresponding to the called Serial Number of Character Units of Sub Variable Character Sets; (n) prefixing or suffixing identification number of Sub Variable Character Sets with Password, is used to identify any Password specific to a particular Sub Variable Character Set, which in turn is used for identification of groups and classification of USERs; (o) replacing with another Sub Variable Character Set generated from the same Master Variable Character Set upon suspected compromise of a Sub Variable Character Set.

13. The system claimed as claim 9, where method of generating and using Sub Variable Character Sets of level 2 or below comprising steps of (a) selecting the total number of Character Units of the Sub Variable Character Set of level 2 or below, (b) identifying Serial Number of Character Units of the of one level up Sub Variable Character Set, the method of identifying the said Serial Number of Character Units adopting at least one of the following ways: (b1) specifying rules of selection such as criteria for filtering data, (b2) specifying discrete numbers, (b3) specifying continuous numbers and (b4) specifying random sequences; the Character units corresponding to the identified Serial Number of Character Units constituting the Sub Variable Character Set of level 2 or below; (c) selecting Character Units including a limited number of Character Units of one level up Sub Variable Character Sets/Master Variable Character Set, duly ensuring that no specific relationship exists, between Character Units of Sub Variable Character Sets any level of same origin; (d) arranging Character Units selected as per steps (a) to (c) of this claim in to any one of the form of lists, tables, arrays and matrices, in which each of the Character Unit is distinctly identifiable and easily readable; (e) assigning unique Serial Number of Character Unit, independent of Serial Number of Character Units of one level up Sub Variable Character Set/Master Variable Character Set to identify each Character Unit in the Sub Variable Character Set of Level 2 or below; (f) specifying the method of identifying/calculating the Serial Number of Character Unit, facilitating USER to read the Character Units corresponding to the Serial Number of Character Units; (g) ensuring the Character Units and the Serial Number of Character Units are unrelated and the Character Units of a Sub Variable Character Set of Level 2 or below are unrelated to each other; (h) assigning a Serial Number/identification number to each Sub Variable Character Set of Level 2 or below, (i) optionally, USER generating Sub Variable Character Set of level 2 or below duly selecting randomly the Character Units provided by SERVICE PROVIDERs from one level up Sub Variable Character Sets; (j) SERVICE PROVIDERs storing Sub Variable Character Sets of level 2 or below in brief form duly identifying Serial Number of Character Units of Sub Variable Character Sets of level 2 or below in terms of Serial Number of Character Units the Master Variable Character Set, the method of identifying the said Serial Number of Character Units, adopting at least one of the following ways: (j1) specifying rules of selection such as criteria for filtering data, (j2) specifying discrete numbers, (j3) specifying continuous numbers and (j4) specifying random sequences; (k) USERs storing Sub Variable Character Sets of Level 2 or below in complete form; wherein when using Sub Variable Character Sets of level 2 or below, (l) the Password Calls are in Serial Number of Character Units of Sub Variable Character Sets of level 2 or below and SERVICE PROVIDER compares with Character Units of Master Variable Character Set corresponding to the called Serial Number of Character Units of Sub Variable Character Sets of level 2 or below; (m) prefixing or suffixing identification number of Sub Variable Character Sets of level 2 or below with Password, is used to identify any Password specific to a particular Sub Variable Character Set of level 2 or below, which in turn is used for identification of groups and classification of USERs; (n) replacing with another Sub Variable Character Set of level 2 or below, generated from the same one level up Sub Variable Character Set upon suspected compromise of a Sub Variable Character Set of level 2 or below.

14. The method of repeated variation of font/distinguishing properties such as font colour, as means of differentiation between same characters of Password, in printed Variable Character Set system of Authentication Devices, including implementing the method by means of a transparent sheet and a memory device with data processor loaded with software, characterized in that (a) generating new Character Units and new authentication devices while retaining original characters, enhancing security against breach of Passwords, enhancing life of authentication Devices and ability of use with any number of SERVICE PROVIDERs, comprising steps of: (b) USER, proposing variation to font/distinguishing properties of characters of Password/Character Units of Variable Character Sets/Sub Variable Character Sets of any level; (c) optionally SERVICE PROVIDER proposing said variation of font/distinguishing properties at regular intervals and USER agreeing to such variations; (d) SERVICE PROVIDER registering the changes; (e) USER using a separate transparent sheet to the size of printed Variable Character Sets/Sub Variable Character Sets of any level, indicating font/distinguishing property variation (f willing USER memorizing the changes; (g) furnishing font/distinguishing properties varied characters for Password.

15. The method of transformation of Variable Character Set system of authentication devices to derive new Character Units including implementing the method by means a memory device with data processor loaded with software comprising steps of: (a) USER proposing at least one rule of transformation of characters of Password/Character Units of authentication device such as shifting Serial number of Character Units of authentication device by a specified number/shifting characters from natural order by a specified number; (b) USER keeping the said rule of transformation separate from authentication device; (c) willing USER memorizing the said rule of transformation on the Character Units or Basic Characters of the authentication device; (d) SERVICE PROVIDER registering the rules; (e) USER furnishing the transformed characters/Character Units for Password.

16. Method of authentication by generating Bilaterally Generated Variable Instant Passwords including a memory device, a data processor loaded with software implementing the method for USER and SERVICE PROVIDER, connected by communication network or not comprising the steps of: (a) USER and SERVICE PROVIDER using a pre agreed authentication device of Variable Character Set system of authentication devices; (b) the Password comprising of a permutation of selected number of Character Units of the authentication device wherein optionally same Character Units are repeated in Password on repetition of same random number within a Call; (c) USER approaching the SERVICE PROVIDER with opening the website or dialogue window or switching on the SERVICE PROVIDER system; (d) SERVICE PROVIDER requesting the USER to furnish USER name or identification number; (e) USER furnishing USER name or identification number; (f) SERVICE PROVIDER (f1) verifying USER name, and refusing the unregistered USER; (f2) identifying and referring to the authentication device of particular USER; (f3) generating a specified number of random numbers wherein the said specified number is at least two; (f4) ensuring each of the generated random number is less than or equal to the total number of Character Units in the authentication device, further validating the said random numbers for compliance of rules preagreed between SERVICE PROVIDER and USER; (f5) sending the random numbers to the USER, termed as Call; (g) USER responding with a continuous-string of Character Units of the authentication device, wherein the serial numbers of Character Units, are the random numbers of Call, in the order of Call, termed as Response, wherein the said continuous string is making Basic Characters indistinguishable as belonging to particular Character Unit; (h) SERVICE PROVIDER when required, requesting the identification number of Sub Variable Character Set of any level as part of Password, along with Call and the USER complying with such request; (i) SERVICE PROVIDER (i1) verifying the Response to the Call with the respective authentication device and authenticating the USER when the Response furnished is correct; (i2) allowing the USER up to preagreed number of chances to furnish the correct Password when the Response furnished in step (i1) is incorrect; (i3) denying access and advising the USER to make subsequent attempt only after preagreed time when USER fails to furnish the correct Password within preagreed number of chances; (i4) making a Call to furnish two Passwords simultaneously/successively in only one single chance to the USER reaching step (i3); (i5) denying access to the USER, who failed to provide correct Password in step (i4) advising such USER to establish authenticity to the satisfaction of the SERVICE PROVIDER through other means, characterized in that (j) dispensing with memorization; (k) enhancing the limit on maximum value of random numbers in Call, imposable by memorization from up to human memorizable level to the total number of Character Units in the authentication device; (l) free from algorithms/pattern forming methods involving multi step procedures to produce Password (m) Call to furnish two Passwords simultaneously/successively prevents breaking and automatically notifies the authentic USER on failed attempts (n) enabling USER verifying authenticity of SERVICE PROVIDER for every transaction.

17. In the method of authentication by generating of Bilaterally Generated Variable Instant Passwords as claimed in claim 16, further comprising the steps of: (a) after the initial identification/authentication, the USER desiring to ascertain the authenticity of SERVICE PROVIDER, by pre arrangement, (b) issuing a Call; (c) SERVICE PROVIDER responding; (d) USER verifying the Response, with the authentication device and authenticating the SERVICE PROVIDER, whereby USER and SERVICE PROVIDER are mutually authenticated.

18. In the method of authentication by generating of Bilaterally Generated Variable Instant Passwords as claimed in claim 16, the valid Response to the Call in step (g) of claim 16 is Bilaterally Generated Variable Instant Password.

19. In the method of authentication by generating of Bilaterally Generated Variable Instant Passwords as claimed in claim 16, the method of generating Non Repeating Bilaterally Generated Variable Instant Passwords comprising of the steps of (a) SERVICE PROVIDER in step (f4) of claim 16, verifying for compliance of the rule according to which, at least one Character Unit constituting a Password occurs for the first time in the said Password, wherein compliance of the said rule making the Passwords never repeat (b) wherein the said rule is observed till all Character Units of pre agreed authentication device are exhausted (c) wherein all the said Character Units of pre agreed authentication device are revived by transformation/font/distinguishing property change to the authentication device.

20. In the method of authentication by generating of Bilaterally Generated Variable Instant Passwords as claimed in claim 16, further comprising the steps of: using the random numbers of Call, concatenated, as Password, in addition to USER furnished Password, thereby generating two Passwords for a transaction.

21. The method of authentication and access restriction of USERs to protect Networks, computer systems, data, software, hardware, camera, mobile phone, and similar systems to the level of specified sector of data storage media using Bilaterally Generated Variable Instant Password system, characterized by ability to control access object wise and access restriction of USER to the level of specified sector of data storage media including the system programs executable by SERVICE PROVIDER systems to which access is controlled, comprising steps of: (a) defining at least one authentication device of Variable Character Set system of authentication devices for each access control module and optionally a second authentication device to provide for eventualities, such as loss of Variable Character Set, transfer of ownership and similar situations for the owner/manufacturer/system administrator to bypass the USER's Password wherein the said second authentication device is used after the owner/manufacturer/system administrator is legally permitted; (b) incorporating a software to form authentication devices initially and modify optionally; (c) providing for SERVICE PROVIDER issuing a Call and USER providing Response; (d) optionally providing for USER requiring authentication of SERVICE PROVIDER issuing a Call and SERVICE PROVIDER providing Response; (e) wherein access is granted for USERs to a session/individual transaction/object after authentication and the said access is restricted to specified sector of SERVICE PROVIDER.

22. The method of authenticating and securing of Internet Contract/Network transactions using one Password for each transaction furnished by a USER, including a memory device, a data processor loaded with software implementing the system for USER and SERVICE PROVIDER, connected by communication network, connected by communication network, {FIG. 1}, using Bilaterally Generated Variable Instant Password System, the method comprising steps of (a) SERVICE PROVIDER and USER (a1) recording their mutual Internet Protocol/Network addresses at the beginning of a session; (a2) placing all unexposed Calls, Passwords, file and message packets in to folders, exchanging the folders after encrypting and access restricting utilizing any one of unexposed Calls/Passwords as Passwords and encryption keys, using a pre agreed cryptographic algorithm to encrypt; wherein all the unexposed Calls/Passwords generated up to a transaction in a session are available for encrypting and access restricting a specific folder by prior agreement; (a3) access restriction and maintaining continuity of link by ensuring IP address from which USER or SERVICE PROVIDER are transacting remains the one and the same from beginning to end of session and by obtaining a variable Password known only to USER and SERVICE PROVIDER for each object exchanged; (a4) confirming correctness of Calls, Passwords and allowing pre agreed number of chances to rectify; exiting upon occurrence of at least one of the following events: failure to furnish valid information, lapse of time, inability to open and inability to decrypt folders; (a5) checking objects exchanged before accepting, the said checks are for compliance of regulations, contract conditions and freedom from undesirable programs like virus; (b) USER furnishing USER Name and issuing a Call termed as ‘initial Call of the session’ to SERVICE PROVIDER; (c) SERVICE PROVIDER creating a folder containing Password for initial Call of the session, a Call, termed as ‘SERVICE PROVIDER's first Call’ and optional message, encrypting and access restricting the folder as detailed in step (a); sending the folder to USER; (d) USER opening and decrypting the folder, checking Password; creating a folder containing Password for SERVICE PROVIDER's first Call, any message, encrypting and access restricting the folder as detailed in step (a); sending the folder to SERVICE PROVIDER; (e) SERVICE PROVIDER opening and decrypting the folder, verifying Password from USER; creating a folder containing next Call, authentication message, encrypting and access restricting the folder as detailed in step (a); sending the folder to USER; (f) USER opening and decrypting the folder, getting the next Call; (g) after an Internet Contract/Network Transaction is created, USER, creating a folder containing Password for the Call received in previous step, and the file or message packet containing the USER's Internet Contract/Network Transaction; encrypting and access restricting the folder as detailed in step (a); sending the folder to SERVICE PROVIDER; (h) SERVICE PROVIDER opening and decrypting the folder, verifying Password furnished by USER, checking and processing the contents of file or message packet; responding by creating a folder containing Call for the next transaction and the file or message packet containing the SERVICE PROVIDER's Internet Contract/Network Transaction; encrypting and access restricting the folder as detailed in step (a); sending the folder to USER; (i) USER opening and decrypting the folder from SERVICE PROVIDER, checking and processing the contents of file or message packet; (j) Repeating steps (g) to (i), till the transactions are completed and (k) exiting after advising SERVICE PROVIDER (l) wherein SERVICE PROVIDER keeping proof for every transaction of USERs including the USER name, the IP address of USER system, the date and time, the details of Internet Contract/Network Transaction, the Call and the Password for each transaction providing direct and computationally non intensive means of tracing all actions/objects of a USER from access to exit.

23. Method of generating multiple Passwords from single Password using User agent software wherein generating multiple passwords from single PIN/equivalent one at a time, user directly performing a plurality of steps of creating a password, upon directing user to furnish password for every transaction, inconveniencing user, software implementation to generate multiple passwords feasibly compromising PIN/equivalent, characterized in that: generating multiple Passwords from single Password in two steps, using software dispensing with effort from USER excepting furnishing first Password, securely within, system provided encryption, comprising steps of (a) USER Agent Software (b) collecting the Call and Password for initial access of USER; (c) determining the total number of Character Units and Character Units from said Call and Password collected in step (b); (d) forming a Sub Variable Character Sets of any level termed as ‘authentication device of the session’ using all Character Units determined in step (c); (e) assigning Serial Number of Character Units to the said Character Units; (f) communicating the assigned Serial Number of Character Units to SERVICE PROVIDER in encrypted folder using the Password for initial access of USER as encryption key; (g) SERVICE PROVIDER making Call from Serial Number of Character Units communicated in step (f); (h) USER Agent Software furnishing Response; (i) Repeating the steps (g) to (h) till end of session; (j) whereby a plurality of Passwords are generated; (k) wherein the first unexposed Call from SERVICE PROVIDER is optionally used as Serial Number of Character Units, dispensing with the need of communicating Serial Number of Character Units in step (f); wherein all Character Units of the USER's authentication device has equal number of characters and SERVICE PROVIDER's Calls for at least 4 Character Units from USER, providing at least 60 unique permutations from the said 4 Character Units.

24. USER Agent Software, integrated with USER system connected through communication network to SERVICE PROVIDER system, the said software combined with Internet Contract/Network Transaction software optionally an independent software comprising modules to perform steps/functions of (a) USER Agent Software adopting to USER name as Internet Protocol/Network address of the computer, wherefrom, USER accesses SERVICE PROVIDER; (b) functioning from the USER Terminal representing USER, transacting with SERVICE PROVIDER; (c) recording Internet Protocol/Network address of SERVICE PROVIDER; (d) forming the authentication device of the session; (e) generating multiple Passwords from a single Password furnished by USER; (f) authenticating USER for individual transactions comprising: (f1) seeking Call (f2) furnishing Response, (f3) confirming correctness of Calls, Passwords and allowing specified number of chances to rectify; (g) exchanging objects after securing and access restricting the said objects to Internet Protocol/Network address of SERVICE PROVIDER; (h) checking for origination of USER's message from USER's system by (h1) ensuring continuity of connection with SERVICE PROVIDER; (h2) ensuring the integrity of command to do the Internet Contract/Network Transaction, through checking the keyboard and other input entries; (i) passing on the objects received from Service Provider to USER after checks such as presence of virus; (j) upon authentication failure, informing the USER to decide corrective action; (k) allowing USER doing authentications directly; (l) denying access to unauthorized user created Internet Contract/Network Transactions; (m) blocking the unauthorized user, from substituting the USER/USER Agent Software/SERVICE PROVIDER, through any other computer; (n) rejecting the attempts to originate Internet Contract/Network Transaction from the USER's Computer, through remote commands; (o) advising SERVICE PROVIDER upon end of transactions and exiting.

25. The method of authenticating and securing of every individual Internet Contract/Network transaction with different Passwords, generating said different Passwords from single Password furnished at the beginning of a session by a known USER using USER Agent Software {FIG. 2}, using Bilaterally Generated Variable Instant Password System, a memory device, a data processor loaded with software implementing the method for USER and SERVICE PROVIDER, connected by communication network, comprising steps of: (a) SERVICE PROVIDER and USER/USER Agent Software (a1) recording their mutual Internet Protocol/Network addresses at the beginning of a session; (a2) placing all unexposed Calls, Passwords, file and message packets in to folders, exchanging the folders after encrypting and access restricting using any one of unexposed Calls/Passwords as Passwords and encryption keys, using a pre agreed cryptographic algorithm to encrypt; wherein all the unexposed Calls/Passwords generated up to a transaction in a session is available for encrypting and access restricting a specific folder by prior agreement; (a3) access restriction and maintaining continuity of link by ensuring IP address from which USER or SERVICE PROVIDER are transacting remains the one and the same from beginning to end of session and by obtaining a variable Password known only to USER and SERVICE PROVIDER, from the respective systems, for each object exchanged; (a4) confirming correctness of Calls, Passwords and allowing pre agreed number of chances to rectify; exiting upon occurrence of at least one of the following events: failure to furnish valid information, lapse of time, inability to open and inability to decrypt folders; (a5) checking objects exchanged before accepting, the checks are for compliance of regulations, contract conditions, and freedom from undesirable programs like virus; (b) USER furnishing USER Name and issuing a Call termed as ‘initial Call of the session’ to SERVICE PROVIDER; (c) SERVICE PROVIDER creating a folder containing Password for initial Call of the session, a Call, termed as ‘SERVICE PROVIDER's first Call’ and optional message, encrypting and access restricting the folder as detailed in step (a); sending the folder to USER; (d) USER opening and decrypting the folder, checking Password; creating a folder containing Password for SERVICE PROVIDER's first Call, any message, encrypting and access restricting the folder as detailed in step (a); sending the folder to SERVICE PROVIDER; (e) SERVICE PROVIDER opening and decrypting the folder, verifying Password from USER; creating a folder containing authentication message, encrypting and access restricting the folder as detailed in step (a); sending the folder to USER; (f) USER opening and decrypting the folder, upon being authenticated, authorizing USER Agent Software for doing transactions passing on Password furnished in step (f) and Call received in step (e); (f) USER Agent Software forming a Sub Variable Character Set of any Level, using all Character Units of the Password furnished in step (f), assigning Serial Number of Character Units as Call received in step (e) or in a different manner and using it as the authentication device of that session.

26. In the method claimed in claim 25, (a) USER Agent Software creating a folder containing assigned Serial Number of Character Units and request for a Call; encrypting and access restricting the folder as in step (a) of claim 25; sending it to SERVICE PROVIDER; (b) SERVICE PROVIDER upon confirming the Internet Protocol/Network address of the USER Agent Software and USER are same, opening and decrypting the folder, registering Serial Number of Character Units, creating a folder containing Call within the authentication device of the session, encrypting and access restricting the folder as in step (a) of claim 25, sending it to USER Agent Software; USER Agent Software opening and obtaining the Call for next transaction; (c) USER creating Internet Contract/Network Transaction and passing on to USER Agent Software; USER Agent Software checking for the origination of Internet Contract/Network Transaction from within USER system such as; (c1) ensuring continuity of connection with SERVICE PROVIDER; (c2) ensuring the integrity of command to do the Internet Contract/Network Transaction, through checking the keyboard and other input entries; (c3) upon confirming the origination, the USER Agent Software, (c4) creating a folder containing Password for the Call obtained in step (b) and the file or message packet containing the USER's Internet Contract/Network Transaction; (c5) encrypting and access restricting the folder as in step (a) of claim 25; (c6) sending the folder to SERVICE PROVIDER; (d) SERVICE PROVIDER opening and decrypting the folder, (d1) verifying Password furnished by USER Agent Software; (d2) checking and processing the contents of file or message packet; (d3) responding by creating a folder containing Call for the next transaction and the file or message packet containing the SERVICE PROVIDER's Internet Contract/Network Transaction; (d4) encrypting and access restricting the folder as in step (a) of claim 25; (d5) sending the folder to USER Agent Software; (e) USER Agent Software opening and decrypting the folder from SERVICE PROVIDER, checking and passing on the file or message packet to USER; retaining the Call; (e repeating steps (c) to (e) till the transactions are completed and exiting after advising SERVICE PROVIDER; (g) USER Agent Software performing further required steps as claimed in claim 24; (h) SERVICE PROVIDER keeping proof for every transaction of USERs including the USER name, the IP address of USER system, the date and time, the details of Internet Contract/Network Transaction, the Call and the Password for each transaction; (i) providing direct and computationally non intensive means of tracing all actions/objects of a USER/SERVICE PROVIDER from access to exit.

27. The method of authenticating and securing of every individual Internet/Network transaction of a Previously Unknown USER including implementing the method by means a memory device, a data processor loaded with software implementing the method for Previously Unknown USER and SERVICE PROVIDER, connected by communication network, comprising steps of (a) Previously Unknown USER's System using USER Agent Software, provided on request by SERVICE PROVIDER; (b) SERVICE PROVIDER and Previously Unknown USER/USER Agent Software (b1) recording their mutual Internet Protocol/Network addresses at the beginning of a session; (b2) placing all unexposed Calls, Passwords and file or message packets in to folders, exchanging the folders after encrypting and access restricting using the Call for a transaction for object exchange from Previously Unknown USER/USER Agent Software to SERVICE PROVIDER and the Password for a transaction for object exchange from SERVICE PROVIDER to Previously Unknown USER/USER Agent Software; (b3) access restriction and ensuring continuity of the link is by ensuring IP address from which the Previously Unknown USER/USER Agent Software or SERVICE PROVIDER are transacting remains the one and the same from beginning to end of session and by obtaining a variable Password known only to Previously Unknown USER/USER Agent Software and SERVICE PROVIDER for each object exchanged from respective systems; (b4) confirming correctness of Calls, Passwords and allowing pre agreed number of chances to rectify; exiting upon failure to rectify or lapse of time or inability to open or decrypt folders; (b5) optionally checking objects exchanged before accepting, the checks are for compliance of regulations, contract conditions as agreed at the commencement of session, and freedom from undesirable programs like virus; (c) Previously Unknown USER requesting a known Internet SERVICE PROVIDER/Network server to facilitate transactions with an Unknown SERVICE PROVIDER, furnishing the domain name of the website or IP address of the SERVICE PROVIDER; (d) Internet SERVICE PROVIDER/Network server authenticating said USER with a Password from that USER's account, conveying the request of the said USER, passing on the USER name, the IP address of the USER and USER data as required to that SERVICE PROVIDER; (e) SERVICE PROVIDER, (e1) considering the request; (e2) when unwilling to transact with that USER, conveying unwillingness through the Internet SERVICE PROVIDER/Network server to that USER; (e3) when willing to transact with that Previously Unknown USER, storing a newly assigned USER name, linked with validated USER data furnished by Internet SERVICE PROVIDER/Network server, IP address of the USER and IP address of Internet SERVICE PROVIDER/Network server for record; (e4) creating a folder containing temporary Sub Variable Character Set of at least eight Character Units and a Call for the Internet SERVICE PROVIDER or Network server, a sub folder for Previously Unknown USER containing temporary USER Name, temporary Sub Variable Character Set of at least eight Character Units having equal number of Basic Characters in all Character Units and a Call for at least four Character Units; (e5) encrypting and access restricting the subfolder to IP address of Previously Unknown USER as USER Name with a Password; (e6) sending the folder to Internet SERVICE PROVIDER or Network server; (f) Internet SERVICE PROVIDER/Network server conveying SERVICE PROVIDER's unwillingness to USER or opening the folder, furnishing Password to SERVICE PROVIDER, passing on the subfolder to USER and exiting; (g) SERVICE PROVIDER checking Password from Internet SERVICE PROVIDER/Network server and upon finding it correct, sending the Password to open the subfolder directly to Previously Unknown USER (h) Previously Unknown USER exiting on unwillingness of SERVICE PROVIDER to transact or opening the subfolder using Password received from SERVICE PROVIDER and obtaining temporary Sub Variable Character Set (i) Previously Unknown USER accessing SERVICE PROVIDER's website, recording IP address of SERVICE PROVIDER, furnishing USER Name, creating folder containing Password to the Call received in the subfolder, encrypting and access restricting as in step (b); sending the folder to SERVICE PROVIDER; (j) SERVICE PROVIDER verifying USER Name, recording IP address of USER, locating authentication device; upon finding the Password as correct, advising about successful authentication, for that session, from when on, that Previously Unknown USER becomes an authenticated but temporary USER to that SERVICE PROVIDER; (k) Previously Unknown USER, authorizing USER Agent Software to act further, passing on the Password and Call used for initial access; (l) USER Agent Software forming a Sub Variable Character Set of any Level, using all Character Units of the Password for initial access, assigning Serial Number of Character Units as Call for initial access or in a different manner and using it as the authentication device of that session.

28. The method of authenticating and securing of every individual Interne/Network transaction of a Previously Unknown USER as claimed in claim 27, further comprising the steps of (a) USER Agent Software seeking a Call; (b) SERVICE PROVIDER upon confirming the Internet Protocol/Network address of the USER Agent Software and temporary USER are same, creating a folder containing Call within the authentication device of the session, encrypting and access restricting the folder as in step (b) of claim 27, sending it to USER Agent Software; USER Agent Software opening and obtaining the Call for next transaction; (c) temporary USER creating Internet Contract/Network Transaction and passing on to the USER Agent Software; USER Agent Software checking for the origination Internet Contract/Network Transaction from within temporary USER's system such as; (c1) ensuring continuity of connection with SERVICE PROVIDER; (c2) ensuring the integrity of command to do the Internet Contract/Network Transaction, through checking the keyboard and other input entries (c3) upon confirming the origination, the USER Agent Software, (c4) creating a folder containing Password for the Call obtained in step (b) and the file or message packet containing the temporary USER's Internet Contract/Network Transaction; (c5) encrypting and access restricting the folder as in step (b) of claim 27; (c6) sending the folder to SERVICE PROVIDER (d) SERVICE PROVIDER opening and decrypting the folder, (d1) verifying Password furnished by USER Agent Software; (d2) checking and processing the contents of file or message packet; (d3) responding by creating a folder containing Call for the next transaction and the file or message packet containing the SERVICE PROVIDER's Internet Contract/Network Transaction; (d4) encrypting and access restricting the folder as in step (b) of claim 27; (d5) sending the folder to USER Agent Software; (e) USER Agent Software opening and decrypting the folder from SERVICE PROVIDER, checking and passing on the file or message packet to temporary USER; retaining the Call (f) Repeating steps (c) to (e) till the transactions are completed and exiting after advising SERVICE PROVIDER (g) USER Agent Software performing further required steps as claimed in claim 24; (h) SERVICE PROVIDER keeping proof for every transaction of USERs including the USER name, the IP address of USER system, the date and time, the details of Internet Contract/Network Transaction, the Call and the Password for each transaction; (i) providing direct and computationally non intensive means of tracing all actions/objects of a Previously Unknown USER/SERVICE PROVIDER from access to exit.

29. The method of Authenticated Dialogue Initiation in the Internet/network between a USER/SERVICE PROVIDER and another party, who is known or Unknown to USER/SERVICE PROVIDER including a memory device, a data processor loaded with software implementing the method for USER and SERVICE PROVIDER, connected by communication network, using Bilaterally Generated Variable Instant Password system comprising steps of (a) Publishing Variable Character Set for Authenticated Dialogue Initiation purpose; (b) USER intending to initiate a dialogue with any party in Internet/Network, calling for a Password from the Variable Character Set published for Authenticated Dialogue Initiation purpose, from the party sought by USER, when sending the Internet Protocol/Network Address of the party; (c) the party called by USER, taking decision on Response to this Call and optionally responding with Password from the said Variable Character Set published for Authenticated Dialogue Initiation purpose; (d) USER checking Internet Protocol/Network Address of the party along with Password; (e) admitting the party when both Internet Protocol/Network Address of the party and Password are correct; (f) USER denying access to uninvited parties (g) USER optionally granting non preferred access, the said non preferred access is limiting the uninvited parties to boundary set by USER.

30. The method of Automatic Classification of USERs upon access including implementing the method by means a memory device, a data processor loaded with software implementing the method for USER and SERVICE PROVIDER, connected by communication network, using Bilaterally Generated Variable Instant Password System, comprising steps of (a) using Master Variable Character Set/Sub Variable Character Sets arrangement; (b) assigning each USER of a particular groups or subgroup, Sub Variable Character Sets with a partly common identification specific to each class of USERs; (c) Calling identification of Sub Variable Character Sets as part of Password; (d) checking the partly common identification of Sub Variable Character Sets of Password; (e) identifying USER groups or subgroups (f) classifying USERs on access based on partly common identification, (g) using the classification arrived in previous step to authorize USER to access sub domains within a domain, thereby, dispensing with USER furnishing input data further to USER Name and Password and dispensing with SERVICE PROVIDER referring to stored information related to the said USER; reducing at least one step of communication.

31. The use of Bilaterally Generated Variable Instant Password System claimed in claims 1 to 30.
